(19) United States
(12) Patent Application Publication
(10) Pub. No.: US 2026/0145764 A1
(43) Pub. Date: May 28, 2026

(54) VARIABLE TRANSMISSION RATIO POWER CONVERSION APPARATUS

(71) Applicant: Crosstepper Me-Mover ApS, Hellerup (DK)

(72) Inventor: Jakob Hiob THILO, Hua Hin (TH)

(21) Appl. No.: 19/401,525

(22) Filed: Nov. 26, 2025

(30) Foreign Application Priority Data
Nov. 26, 2024 (EP) 24215481.3

(51) Int. Cl. B62M 1/28; B62M 9/06

(52) U.S. Cl. CPC B62M 1/28; B62M 9/06

(57) ABSTRACT

An apparatus, comprising a pusher, a flexible element, and an asymmetric rotor, wherein a path of the flexible element is a function of a position of the pusher, and a rotational position of the asymmetric rotor is a function of the path.

### BACKGROUND OF THE DISCLOSURE

### Field of the Disclosure

The present disclosure relates to a power conversion apparatus as well as to a vehicle and to an exercise machine. The present disclosure also relates to a method.

### Description of the Related Art

A variety of power conversion apparatuses are known. Known power conversion apparatuses include apparatuses used to convert human-generated power into rotary power.

The present disclosure expounds upon this background.

### SUMMARY OF THE PRESENT DISCLOSURE

The aim of the present summary is to facilitate understanding of the present disclosure. The summary thus presents concepts and features of the present disclosure in a more simplified form and in looser terms than the detailed description below and should not be taken as limiting other portions of the present disclosure.

Loosely speaking, the present disclosure discloses an apparatus that uses a pusher to alter the path of a flexible element and drive an asymmetric rotor. The inventor has found that such an apparatus is useful for converting power at a desirable variable transmission ratio.

Still loosely speaking, the present disclosure discloses a method comprising manually assembling a portion of a flexible element into a hollow of a rotor in a direction perpendicular to a preferred bending plane of the flexible element. The inventor has found that such a method is useful for simplifying assembly as well as repair of a power conversion apparatus.

Other objects, advantages and embodiments of the present disclosure will become apparent from the detailed description below, especially when considered in conjunction with the accompanying drawings.

### BRIEF DESCRIPTION OF THE DRAWINGS

The Figures show:

FIG. 1A a schematic depiction of an apparatus in accordance with the present disclosure,

FIG. 1B a schematic depiction of further aspects of the apparatus of FIG. 1A,

FIG. 2A a schematic depiction of an apparatus in accordance with the present disclosure,

FIG. 2B a schematic depiction of further aspects of the apparatus of FIG. 2A,

FIG. 2C a schematic depiction of further aspects of the apparatus of FIG. 2A,

FIG. 2D a schematic depiction of further aspects of the apparatus of FIG. 2A,

FIG. 2E a schematic depiction of further aspects of the apparatus of FIG. 2A,

FIG. 2F a schematic depiction of further aspects of the apparatus of FIG. 2A,

FIG. 3A a schematic depiction of a rotor in accordance with the present disclosure,

FIG. 3B a schematic depiction of further aspects of the rotor of FIG. 3A,

FIG. 3C a schematic depiction of further aspects of the rotor of FIG. 3A,

FIG. 4 a schematic depiction of an apparatus in accordance with the present disclosure,

FIG. 5 a schematic depiction of a power conversion ratio of an apparatus in accordance with the present disclosure,

FIG. 6A a schematic depiction of an apparatus in accordance with the present disclosure,

FIG. 6B a schematic depiction of further aspects of the apparatus of FIG. 6A,

FIG. 7A a schematic depiction of a rotor in accordance with the present disclosure,

FIG. 7B a schematic depiction of further aspects of the rotor of FIG. 7A,

FIG. 8A a schematic depiction of an apparatus in accordance with the present disclosure,

FIG. 8B a schematic depiction of further aspects of the apparatus of FIG. 8A

FIG. 8C a schematic depiction of further aspects of the apparatus of FIG. 8A,

FIG. 9A a schematic depiction of an apparatus in accordance with the present disclosure,

FIG. 9B a schematic depiction of further aspects of the apparatus of FIG. 9A,

FIG. 9C a schematic depiction of further aspects of the apparatus of FIG. 9A,

FIG. 9D a schematic depiction of further aspects of the apparatus of FIG. 9A,

FIG. 10A a schematic depiction of an apparatus in accordance with the present disclosure,

FIG. 10B a schematic depiction of further aspects of the apparatus of FIG. 10A,

FIG. 11A a schematic depiction of an apparatus in accordance with the present disclosure,

FIG. 11B a schematic depiction of further aspects of the apparatus of FIG. 10A, and

FIG. 12 a schematic depiction of an apparatus in accordance with the present disclosure.

### DETAILED DESCRIPTION

The various embodiments of the present disclosure and of the claimed invention, in terms of both structure and operation, will be best understood from the following detailed description, especially when considered in conjunction with the accompanying drawings.

Before elucidating the embodiments shown in the Figures, the various embodiments of the present disclosure will first be described in general terms.

The present disclosure discloses an apparatus, e.g. a power conversion apparatus. The apparatus may be a purely mechanical apparatus. The apparatus may be comprise/consist of mechanical and hydraulic components. The apparatus may (be structured to) convert human-generated mechanical power into rotary power. The apparatus may (be structured to) transmit power from an input element to an output element at a transmission ratio that (steplessly) varies as a function of a position of the input element. The apparatus may constitute (a portion of) a vehicle, e.g. a human-powered vehicle. The apparatus may (be structured to) convert human-generated mechanical power into rotary power that drives a wheel of the vehicle. The apparatus may constitute (a portion of) an exercise machine, e.g. a non-vehicular and/or stationary exercise machine. The apparatus may comprise at least one of a flywheel, a fan, and an eddy current brake. The apparatus may (be structured to) convert human-generated mechanical power into rotary power that drives the at least one of a flywheel, a fan, and an eddy current brake. The apparatus may define a forward and/or a rearward direction. The apparatus may define an upward and/or a downward direction.

The apparatus may comprise a (rigid) frame. The frame may comprise metal and/or carbon fiber structures, e.g. metal tubing and/or carbon-fiber tubing. The metal and/or carbon fiber structures may constitute at least 70%, at least 80%, at least 90%, at least 95%, or an entirety of the frame by weight and/or volume. The frame may have an overall weight of less than 10 kg, less than 7 kg, or less than 5 kg. The apparatus may comprise a first axle. The first axle may be rotatably mounted to the frame. The first axle may be rotatably mounted to a rearward portion of the frame, e.g. to a portion of the frame situated within a rearmost quarter volume of a minimally-sized, imaginary rectangular parallelepiped cuboid enclosing the frame. The flywheel or the fan may be mounted to the first axle, e.g. such that the flywheel/fan and the first axle rotate as a unit. The first axle may be an input shaft of the eddy current brake. Similarly, the (rear) wheel may be mounted to the first axle, e.g. such that the (rear) wheel and the first axle rotate as a unit. The apparatus may comprise a transmission. The transmission may comprise an input shaft and/or an output shaft. The output shaft may constitute the output element of the apparatus. The transmission may (be structured to) alter a relative rotational velocity of the input shaft to the output shaft. The transmission may comprise a (one-way) clutch. The clutch may (be structured to) selectively transfer power (directly or indirectly) from the input shaft to the output shaft, e.g. as a function of a state of the clutch. The clutch may (be structured to) transfer power from the input shaft to the output shaft exclusively in an operating state exhibiting an angular velocity (in a driving direction) at the input shaft greater than an angular velocity at the output shaft. The transmission may comprise a plurality of gears and/or a plurality of sprockets. The transmission may (be structured to) use the gears/sprockets to alter a gear ratio between the input shaft and the output shaft. The apparatus may comprise a front wheel. The front wheel may be situated within a forwardmost quarter volume of a minimally-sized, imaginary rectangular parallelepiped cuboid enclosing the apparatus. The front wheel may be (directly or indirectly) rotatably mounted to a forward portion of the frame, e.g. to a portion of the frame situated within a forwardmost quarter volume of the minimally-sized, imaginary rectangular parallelepiped cuboid enclosing the frame. The apparatus may comprise a steering column. The steering column may be rotatably mounted to a forward portion of the frame, e.g. to a portion of the frame situated within a forwardmost quarter volume of the minimally-sized, imaginary rectangular parallelepiped cuboid enclosing the frame. The front wheel may be rotatably mounted to the steering column. The apparatus may comprise handlebars. The handlebars may be mounted to the steering column. The steering column and/or handlebars may be situated within a forwardmost quarter volume of the minimally-sized, imaginary rectangular parallelepiped cuboid enclosing the apparatus.

The apparatus may comprise a flexible element, e.g. a roller chain, (toothed or untoothed) belt, or wire rope. The flexible element may be a flexible element having a nominal tensile strength of at least 1,000 kg, at least 1,500 kg, at least 2,000 kg, or at least 2,500 kg. The flexible element may be substantially non-stretchable. The flexible element may be a flexible element having a nominal bend radius of less than 10 mm, less than 15 mm, or less than 20 mm. The flexible element may define a path, e.g. a path along a central longitudinal axis of the flexible element. The apparatus may be structured such that the path comprises a first bend and/or a second bend. A direction of curvature of the first bend may be opposite a direction of curvature of the second bend. The first bend and the second bend may (jointly) form an S-shape. The flexible element may exhibit a preferred bending direction or a preferred bending plane. The flexible element may define a plane, e.g. a preferred bending plane of the flexible element. The flexible element may comprise a first end and a second end. An end portion of the flexible element proximate to the first end may constitute a first end portion. The flexible element may have an overall length, e.g. between the first end and the second end, of less than 50 cm, less than 40 cm, less than 35 cm, less than 30, or less than 25 cm.

The apparatus may comprise a pusher. The pusher may constitute the input element of the apparatus. The path of the flexible element may be a function of a position of the pusher. The pusher may (be structured and operably arranged to) push against the flexible element and alter the path of the flexible element. The path of the flexible element may comprise a bend in the portion of the flexible element in contact with the pusher. (Throughout the present disclosure, for the sake of brevity, a (respective) portion of the flexible element in contact with the pusher (in a respective state of the apparatus/pusher) may be termed a “pusher-contacting portion”.) The path of the flexible element may comprise a bend as a result of a position of the pusher relative to the flexible element and/or a result of a force of the pusher against the flexible element. The bend may constitute the aforementioned second bend. The pusher may comprise a rotary element, e.g. a wheel, roller, or pulley, that contacts the flexible element. The rotary element may have a minimal radius of at least 7 mm, at least 10 mm, at least 12 mm, or at least 15 mm. The pusher may comprise a curved slide surface that contacts the flexible element. The curved slide surface may have a minimal radius of curvature of at least 7 mm, at least 10 mm, at least 12 mm, or at least 15 mm. The pusher may comprise a rigid arm. Metal and/or carbon fiber material may constitute at least 70%, at least 80%, at least 90%, at least 95%, or an entirety of the arm by weight and/or volume. The pusher/arm may have an elongate shape. The rotary element/slide surface may be situated at a distal end of the pusher/arm.

The apparatus may comprise a (metallic) rotor. The rotor may constitute the output element of the apparatus. The rotor may be situated downward from the pusher. The rotor may be asymmetric, e.g. relative to an axis of rotation of the rotor. For example, the rotor may exhibit an asymmetric cross-section in a plane perpendicular to the axis of rotation. The rotor may be structured such that a radial distance from the axis of rotation to a shortest path enclosing a circumference of the rotor gradually increases (roughly continuously) over at least 180°, at least 220°, at least 240° or at least 270° (of the 360° circumscribed by that shortest path). The rotor may be structured such that the longest radial distance from the axis of rotation to the shortest path enclosing the circumference of the rotor is at least 1.5 times, at least 2 times, at least 2.5 times, at least 3 times, at least 3.5 times, or at least 4 times the shortest radial distance from the axis of rotation to the shortest path enclosing the circumference of the rotor. The rotor may comprise a plurality of teeth (on an outer circumference of the rotor). The teeth may be structured to engage the flexible element. For example, the teeth may be structured to engage openings, depressions, hollows, grooves, and/or teeth defined by the flexible element. The rotor may be structured such that a radial distance from the axis of rotation to a central longitudinal axis of the flexible element in a fully engaged state with the rotor gradually increases (roughly continuously) over at least 180°, at least 220°, at least 240° or at least 270° (of a full 360° circumscription of the rotor). The rotor may be structured such that, in the fully engaged state, the longest radial distance from the axis of rotation to the central longitudinal axis of the flexible element is at least 1.5 times, at least 2 times, at least 2.5 times, at least 3 times, at least 3.5 times, or at least 4 times the shortest radial distance from the axis of rotation to the central longitudinal axis of the flexible element. The rotor may comprise an undercut (that defines a circumference of the rotor). The rotor may be a plate-like structure. The rotor may have a maximum dimension in a direction perpendicular to the axis of rotation that is at least 4 times larger than a maximum dimension in a direction parallel to the axis of rotation. The rotor may be mounted to a rotor axle, e.g. such that the rotor and the rotor axle rotate as a unit. The rotor axle may be the first axle. The rotor axle may be an input shaft of the transmission, e.g. an input shaft of the clutch. The apparatus may define a driving direction of the rotor. The apparatus may be structured such that a rotation of the rotor in the driving direction results in a rotation of the axle in a utility direction, e.g. in a direction that yields a (forward) driving of the wheel.

The apparatus may be structured such that the pusher is operable between an unactuated position and a fully actuated position. The apparatus and/or pusher may be structured such that the pusher defines a path between two points, e.g. between a fixture (that secures a first end of the flexible element) and the rotor, which path lengthens as a function of a (rotational) position of the pusher. The apparatus and/or pusher may be structured such that the path comprises at least one bend or at least two bends exhibiting an angle that decreases as the pusher transitions from the unactuated position to the fully actuated position, e.g. from an angle greater than 110° or greater than 140° to an angle of less than 90°, less than 60°, or less than 45°. The unactuated position may constitute a first end of range of motion of the pusher, and the fully actuated position may constitute a second end of range of motion of the pusher. The apparatus may be structured such that (the distal end of) the pusher moves along a(n invariable) first path (relative to the frame) from the unactuated position to the fully actuated position. The apparatus may be structured such that (the distal end of) the pusher returns along the first path from the fully actuated position to the unactuated position. The apparatus may be structured such that (the distal end of) the pusher returns from the fully actuated position to the unactuated position along a(n invariable) second path (relative to the frame) that differs from the first path. The apparatus may be structured such that a transition of the pusher from the unactuated position to the fully actuated position effects a motion of the distal end of the pusher in a rearward and/or upward direction. The apparatus may be structured such that a transition of the pusher from the unactuated position to the fully actuated position effects a rotary motion of the pusher.

The apparatus may be structured such that, for at least 90%, at least 95%, or at least 98% of a length of the first path from the unactuated position to the fully actuated position, the pusher contacts the flexible element. The apparatus may be structured such that, in every operating state of the apparatus, the pusher contacts the flexible element. The apparatus may be structured such that (in at least one or in every operating state of the apparatus) the pusher contacts less than 30%, less than 25%, less than 20%, less than 15%, less than 10%, or less than 5% of an overall length of the flexible element. The apparatus may be structured such that (in at least one or in every operating state of the apparatus) an initial motion of the pusher toward the fully actuated position is perpendicular to the path of the pusher-contacting portion of the flexible element.

The (first end of the) flexible element may be (directly or indirectly) attached to the frame. As touched upon above, the apparatus may comprise a fixture (directly or indirectly) attached to the frame. The (first end/a first portion of the) flexible element may be secured to the fixture. As such, the fixture may secure (a first portion/the first end of) the flexible element to the frame. The apparatus may be structured such that (a first portion/the first end of) the flexible element is manual attachable to the frame (directly or indirectly), e.g. by a movement of the flexible element (exclusively) in a direction within 20° of perpendicular, within 15° of perpendicular, within 10° of perpendicular, within 5° of perpendicular, within 1° of perpendicular, or perpendicular to a preferred bending plane of the flexible element. The frame and/or the fixture may comprise a hollow structured to matingly receive the first portion/the first end of the flexible element, e.g. by a (manually effected) movement as described above. The apparatus may comprise a peg. The peg may be situated in the hollow. The peg may be sized and/or arranged to receive a loop formed by (a portion of) the flexible element. The hollow and/or peg may be structured to secure the first portion/the first end of the flexible element to the fixture/frame (in a manner that prevents the flexible element from being separated from the fixture/frame in response to a force along a longitudinal axis of the flexible element (in all operating states of the apparatus). The force may be a force in excess of 1,000 kg, 1,500 kg, 2,000 kg, or 2,500 kg.

The (second end of the) flexible element may be (directly or indirectly) attached to the rotor. The rotor may be structured such that (the second end of) the flexible element is manual attachable to the rotor, e.g. by a movement of the flexible element (exclusively) in a direction within 20° of perpendicular, within 15° of perpendicular, within 10° of perpendicular, within 5° of perpendicular, within 1° of perpendicular, or perpendicular to a preferred bending plane of the flexible element and/or (exclusively) in a direction within 20° of parallel, within 15° of parallel, within 10° of parallel, within 5° of parallel, within 1° of parallel, or parallel to the axis of rotation of the rotor. The rotor may comprise a hollow structured to matingly receive the second end of the flexible element, e.g. by a (manually effected) movement as described above. The hollow may be structured to secure the second end of the flexible element to the rotor (in a manner that prevents the flexible element from being separated from the rotor in response to a force along a longitudinal axis of the flexible element (in all operating states of the apparatus). The force may be a force in excess of 1,000 kg, 1,500 kg, 2,000 kg, or 2,500 kg. The hollow may form (a portion of) the undercut.

The apparatus may be structured such that a transition of the apparatus from a first state, e.g. from an unactuated state of the pusher (corresponding to the unactuated position), to a second state, e.g. to a fully actuated state of the pusher (corresponding to the fully actuated position), results in (an unwrapping of a portion of the flexible element from a (partial) circumference of the rotor and) a rotation of the rotor in the driving direction.

The apparatus may be structured such that a rotational position of the rotor is a function of the path of the flexible element. The apparatus may be structured such that a length of the path from the first end of the flexible element to a most proximate contact point of the flexible element with the rotor (as measured along the path from the first end) delimits a maximal rotation of the rotor in a non-driving direction opposite the driving direction (from an end of range position of the rotor in the driving direction). The apparatus may be structured such that, in the first state of the apparatus, the path delimits the rotor to a first maximal rotation in the non-driving direction. The apparatus may be structured such that, in the second state of the apparatus, the path delimits the rotor to a second maximal rotation in the non-driving direction. The first maximal rotation may be greater than the second maximal rotation by at least 180°, at least 240°, at least 300°, or at least 360°. The rotor may (be structured and arranged to) influence an angle (of a bend) in the path of the flexible element, e.g. an angle/bend formed by contact of the pusher and the flexible element. The rotor may be structured and arranged such that (an asymmetry of) the rotor reduces the angle (of the bend) by at least 5°, at least 8°, or at least 12° in response to a rotation of the rotor, e.g. a rotation of the rotor (resulting from a pulling force of the flexible element) resulting from a movement of the pusher from the unactuated position to the fully actuated position. The angle/bend may constitute the aforementioned second bend.

The apparatus may be structured such that a length of the path from the first end of the flexible element to a most proximate contact point of the flexible element with the rotor (as measured along the path from the first end) delimits a length of a portion of the flexible element that can wrap against a (partial) circumference of the rotor.

The apparatus may be structured such that, in the first state of the apparatus, a portion of the flexible element is wrapped against a first partial circumference of the rotor. The apparatus may be structured such that, in the first state of the apparatus, a portion of the flexible element (proximate to the second end) abuts at least 150°, at least 180°, at least 210°, or at least 240°, at least 270°, at least 300°, at least 330°, or, e.g. in the case of a rotor comprising an undercut, more than 360° of a radially outward facing surface of the rotor (as measured in a circumferential direction). The radially outward facing surface may comprise a portion of an outer circumference of the rotor at which the radial distance from the axis of rotation to a shortest path enclosing the circumference of the rotor is longest. The radially outward facing surface may comprise/consist of the outer circumference of the rotor. The radially outward facing surface may comprise an interior surface of the rotor, e.g. a radially outward facing surface in an undercut of the rotor. The apparatus may be structured such that, in the first state of the apparatus, a first side of the flexible element abuts the radially outward facing surface.

The apparatus may be structured such that, in the second state of the apparatus, a (lesser) portion of the flexible element is wrapped against a second partial circumference of the rotor (that is smaller than the first partial circumference). The apparatus may be structured such that, in the second state of the apparatus, the flexible element does not contact an outer circumference of the rotor. The apparatus may be structured such that, in the second state of the apparatus, a (lesser) portion of the flexible element (proximate to the second end) abuts less than 120°, less than 90°, less than 60°, less than 30°, or less than 10° of the radially outward facing surface (as measured in the circumferential direction). The apparatus may be structured such that, in the second state of the apparatus, the flexible element does not engage teeth on (a radially outward facing surface of) the rotor. The apparatus may be structured such that, in the second state of the apparatus, the flexible element inhibits a rotation of the rotor in a driving direction. The apparatus may be structured such that, in the second state of the apparatus, a second side of the flexible element abuts a radially inward facing surface of the rotor.

The apparatus may comprise a (metallic or plastic) guide. The guide may be (directly or indirectly) attached to the frame, e.g. at a position upward of the rotor. The path of the flexible element may be a function of a shape and/or position of the guide. The guide may (be structured and arranged to) push against the flexible element and influence the path of the flexible element. The guide may (be structured and arranged to) influence an angle (of a bend) in the path of the flexible element formed by contact of the pusher and the flexible element (intermediate a portion of the flexible element that contacts the guide and a portion of the flexible element that contacts the rotor). The guide may be structured and arranged such that the guide reduces an angle of the bend by at least 5°, at least 10°, or at least 15° in response to a movement of the pusher from the unactuated position to the fully actuated position, e.g. in response to a second half of a movement of the pusher from the unactuated position to the fully actuated position. The angle/bend may constitute the aforementioned second bend. The guide may comprise an arch-shaped outer surface that bulges from a central region of the guide. The arch-shaped outer surface may constitute an entire (longitudinal) side of the guide. The guide may be a plate-like structure. The guide may have a maximum longitudinal dimension that is at least 5 times, at least 8 times, or at least 10 times larger than a maximum dimension in a direction perpendicular to the maximum longitudinal dimension.

The guide may be adjustably attached to the frame. The apparatus and/or frame and/or guide may be structured to permit the guide to be mounted to the frame at any of a plurality of positions relative to the frame. The guide may be slidingly mounted to the frame. The apparatus may comprise an adjustment screw, rotation of which alters a position of the (slidingly mounted) guide relative to the frame. The adjustment screw may comprise a knob (to allow manual rotation of the adjustment screw). The guide may comprise a plurality of mounting holes. Similarly, the guide may comprise at least one mounting slot. The guide may be mountable to the frame in a first position (relative to the frame). The guide may be mountable to the frame in a second position (relative to the frame) that differs from the first position. The guide may be mountable to the frame in a third position (relative to the frame) that differs from the first position and the second position. The apparatus may be structured such that a repositioning of the guide from the first position to the second and/or third position moves the guide closer to the rotor. The apparatus may be structured such that a repositioning of the guide from the first position to the second and/or third position reduces an angle of the second bend. The apparatus may be structured such that a repositioning of the guide from the second position to the third position reduces an angle of the second bend. The angle of the second bend may be measured as described below. The apparatus may be structured such that a repositioning of the guide from the first position to the second and/or third position alters a relative position of the guide to the frame in a direction within 20° of parallel, within 15° of parallel, within 10° of parallel, within 5° of parallel, within 1° of parallel, or parallel to reference line. The reference line may be a line bisecting the arch (formed by the arch-shaped outer surface), a line bisecting and perpendicular to a base of the arch, a line representing a maximum rise of the arch, and/or a line perpendicular to a flat side of the guide opposite the arch. The guide may be attached to the fixture or be formed with the fixture from a single unit of material. The guide may be distinct from the fixture.

The guide may comprise a plurality of teeth (on an outer surface of the guide, e.g. on the curved outer surface). The guide may comprise teeth on at least one side or on at least two sides of the guide. The guide may comprise teeth on a lateral and/or longitudinal side of the guide. The teeth may be structured to engage the flexible element. For example, the teeth may be structured to engage openings, depressions, hollows, grooves, and/or teeth defined by the flexible element. The apparatus may be structured such that at least one or at least two of the teeth engage(s) the flexible element in every operating state of the apparatus. The number of teeth engaged by the flexible element may be a function of the operating state of the apparatus.

The apparatus may be structured such that the path of the flexible element comprises a bend of at least 110°, at least 120°, at least 130°, or at least 140°, e.g. in a first end portion of the flexible element (proximate to the first end of the flexible element). The bend may constitute the aforementioned first bend. The fixture and/or the guide may be structured and positioned such that (a path of) the flexible element must bend by at least 110°, at least 120°, at least 130°, or at least 140° in order for the flexible element, attached to the fixture, to contact (the distal end of) the pusher, e.g. to contact the rotary element/slide surface of the pusher.

As touched upon above, the path of the flexible element may comprise a bend, e.g. the aforementioned second bend, in the pusher-contacting portion of the flexible element, e.g. as a result of a force of the pusher against the flexible element. An angle of the bend may be measured between two portions of the flexible element adjacent to the pusher-contacting portion of the flexible element. For example, the angle of the bend may be measured between a first portion of the flexible element and a second portion of the flexible element. The first portion may be immediately adjacent to the pusher-contacting portion (and may form a portion of the path of the flexible element from the pusher-contacting portion to the first end of the flexible element). The second portion may be immediately adjacent to the pusher-contacting portion (and may form a portion of the path of the flexible element from the pusher-contacting portion to the second end of the flexible element). The angle (of the bend) in the first state of the apparatus may be at least two times, at least three times, or at least four times the angle (of the bend) in the second state of the apparatus. In the first state, the angle may be greater than 90°, greater than 120°, or greater than 150°. In the second state, the angle may be less than 90°, less than 60°, or less than 45°. The apparatus may be structured such that a motion of the pusher (from the unactuated position) toward the fully actuated position effects a continuous decrease the angle.

The rotor may comprise a body and an adjustor. The adjustor may be adjustably attached to the body. The adjustor may define a maximum radius of the rotor. The adjustor may define a portion of the outer circumference of the rotor, e.g. a portion of the outer circumference that defines a maximum radius of the rotor. The rotor may be structured to permit the adjustor to be (tool-lessly) mounted to the body at any of a plurality of positions relative to the body. The adjustor and/or body may comprise a plurality of mounting holes. Similarly, the adjustor and/or body may comprise a plurality of mounting pins (that engage corresponding mounting holes on the other of the adjustor/body). The adjustor may be (tool-lessly) mountable to the body in a first position (relative to the body). The adjustor may be (tool-lessly) mountable to the body in a second position (relative to the body) that differs from the first position. The adjustor may be (tool-lessly) mountable to the body in a third position (relative to the body) that differs from the first position and the second position. The rotor may be structured such that a (radial) distance from the axis of rotation to a portion of the outer circumference defined by the adjustor is a function of a configuration of the adjustor and the body. The rotor may be structured such that, in a second rotor configuration comprising the adjustor mounted to the body in the second position, the longest radial distance from the axis of rotation to a shortest path enclosing the circumference of the rotor (via the adjustor) is at least 5% or at least 10% longer than the longest radial distance from the axis of rotation to a shortest path enclosing the circumference of the rotor (via the adjustor) in a first rotor configuration comprising the adjustor mounted to the body in the first position. The rotor may be structured such that, in a third rotor configuration comprising the adjustor mounted to the body in the third position, the longest radial distance from the axis of rotation to the shortest path enclosing the circumference of the rotor (via the adjustor) is at least 5% or at least 10% longer than the longest radial distance from the axis of rotation to the shortest path enclosing the circumference of the rotor (via the adjustor) in the second rotor configuration.

The apparatus may comprise a pedal. The pedal may constitute the input element of the apparatus. The pedal may be movably mounted (directly or indirectly) to the frame, e.g. (exclusively) via a rearmost third, a rearmost quarter, or a rearmost fifth of the pedal. The pedal may be pivotally connected to the frame, e.g. at a rearmost third, a rearmost quarter, or a rearmost fifth of the pedal. The pedal may comprise a foot-receiving portion, e.g. in a forwardmost half, a forwardmost third, or a forwardmost quarter of the pedal. The pedal may comprise a (rigid) arm. The foot-receiving portion may be pivotally connected to the arm. The apparatus may comprise a pivot (for connecting the pedal to the frame). A first portion of the pivot may be (rigidly) connected to (the arm of) the pedal. A second portion of the pivot may be (rigidly) connected to the frame. The fixture may be mounted to the frame adjacent the pivot. The pedal may comprise an extension, e.g. an extension that extends rearward from a region of the pedal connected to the pivot. The extension may form an (arm) portion of the pusher. The apparatus may be structured such that motion of the pedal, i.e. a pedaling motion, results in a rotational and/or translational motion of a forward portion, e.g. a forwardmost half, of the pedal. The apparatus may be structured such that a pedaling motion (from a first end of range to a second end of range) moves a forward portion, e.g. a forwardmost portion, of the pedal at least two times, at least three times, or at least four times as far as a rearward portion, e.g. a rearmost portion, of the pedal. The pedal may comprise metal and/or carbon fiber structures, e.g. metal tubing and/or carbon-fiber tubing. The metal and/or carbon fiber structures may constitute at least 70%, at least 80%, at least 90%, at least 95%, or an entirety of the pedal and/or arm by weight and/or volume. The apparatus may be structured such that the pedal is operable between a first position, e.g. a first end of range position, and a second position, e.g. a second end of range position. The apparatus may be structured such that motion of the pedal in a downward direction and/or in a direction toward the frame moves the pedal toward the second position. The apparatus may be structured such that an external force, e.g. a muscle force of a user, is required to move the pedal toward the first position, e.g. from the second position to the first position.

The pusher may be mechanically and/or hydraulically linked to the pedal, e.g. such that motion of the pedal causes motion of the pusher. The pusher may be linked to the pedal such that motion of the pedal toward the second position moves the pusher toward the fully actuated position. The pusher may be linked to the pedal such that motion of the pedal toward the first position moves the pusher toward the unactuated position. The pusher may be linked to the pedal such that a positioning of the pedal in the second position results in a positioning of the pusher in the fully actuated position. The pusher may be linked to the pedal such that a positioning of the pedal in the first position results in a positioning of the pusher in the unactuated position. The pusher may be directly connected to the pedal, e.g. at a proximal end of the pusher. The pusher may be welded and/or riveted and/or bolted to the pedal. The apparatus may comprise a linking component that links the pedal to the pusher. The apparatus may comprise a (mechanical and/or hydraulic) linking assembly that links the pedal to the pusher. The apparatus may be structured such that the linking component/assembly pushes the pusher toward the fully actuated position in response to motion of the pedal toward the second position. Similarly, the apparatus may be structured such that the linking component/assembly pulls the pusher toward the fully actuated position in response to motion of the pedal toward the second position.

As touched upon above, the apparatus may be structured such that a transition of the pusher from the unactuated position to the fully actuated position effects a rotary motion of the pusher. The pusher may be a rotary pusher. The pusher may comprise a first body. The first body may be rotatably mounted to a second body. The first body may have an annular shape. The first body may form a ring around the second body. The second body may be an element of the pusher. The second body may be an element of the frame. The second body may be rigidly fastened to the frame. The pusher may comprise a plurality of rollers, e.g. a first plurality of rollers mounted on the first body and/or a second plurality of rollers mounted on the second body. The rollers may be arranged to form a smooth path for the flexible element, e.g. a flat belt. The rollers may be arranged to form a path that contacts alternating sides of the flexible element. The first plurality of rollers may extent perpendicularly from a surface of the first body, e.g. such that, for any/each of the rollers, a respective axis of rotation of the respective individual roller is within 10° of parallel, within 5° of parallel, within 1° of parallel, or parallel to an axis of rotation of the first body. The second plurality of rollers may extent perpendicularly from a surface of the second body, e.g. such that, for any/each of the rollers, a respective axis of rotation of the respective individual roller is within 10° of parallel, within 5° of parallel, within 1° of parallel, or parallel to an axis of rotation of the first body. The first plurality of rollers may be symmetrically arranged on the first body. The second plurality of rollers may be symmetrically arranged on the second body. The rollers may be arranged on the first/second body such that the rollers are in linear arrangement at a position of the pusher intermediate the unactuated position and the fully actuated position. The rollers may be arranged such that the pusher defines a path between two points, which path lengthens as a function of a rotational position of the pusher. The rollers may be arranged such that the path comprises at least one bend or at least two bends exhibiting an angle that decreases as the pusher transitions from the unactuated position to the fully actuated position, e.g. from an angle greater than 110° or greater than 140° to an angle of less than 90°, less than 60°, or less than 30°. The apparatus may comprise a set of gears. The rotary pusher may be linked to the pedal by a set of gears, e.g. by a set of gears that transmits a rotary motion of the pedal to the rotary pusher. The apparatus may comprise at least one gear (for linking the pedal to the rotary pusher). The pedal may comprise a (partial) gear. The (partial) gear may be rigidly attached to the arm of the pedal.

The fixture may comprise a rack, e.g. a rack comprising a plurality of notches. The rack may define a plurality of mounting points (for the first end of the flexible element). The mounting points may be arranged along an arc, e.g. an equidistant arc relative to a contact point of the flexible element and a roller. The roller may be the first roller from the rack toward an opposite end of the flexible element along the path of the flexible element. The apparatus may be structured such that a choice of mounting point influences an angle of at least one bend in the path of the flexible element defined by the (rotary) pusher, e.g. in every operating state of pusher.

The apparatus may comprise a retractor. The retractor may be structured to retract the rotor to the unactuated position in response to a return of the pedal to the first position. The retractor may comprise second flexible element, e.g. a belt or wire. The retractor may comprise an elastic element, e.g. a spring. The retractor may comprise a cylinder. The apparatus may be structured such that rotation of the cylinder results in rotation of the rotor and vice-versa. The cylinder may be a cylindrical surface of the rotor. A first end of the second flexible element may be attached to the cylinder. A second end of the second flexible element may be attached to the pedal (via the elastic element). The apparatus may be structured such that rotation of the rotor in the driving direction results second flexible element being wrapped onto an outer circumference of the cylinder. The apparatus may be structured such that a pulling of the second flexible element in an “unwrapping” direction results in a rotation of the rotor in a direction opposite the driving direction.

The present disclosure discloses a method. The method may comprise manually assembling a portion, e.g. a second end, of a (second) flexible element into a hollow of a rotor, e.g. into a hollow of a rotor as described above. The method may comprise manually assembling another portion, e.g. a first end, of the (second) flexible element into a hollow of a fixture, e.g. into a hollow of a fixture as described above. The method may comprise manually disassembling a portion, e.g. a second end, of a (first) flexible element from a hollow of a rotor, e.g. from a hollow of a rotor as described above. The method may comprise manually disassembling another portion, e.g. a first end, of the (first) flexible element from a hollow of a fixture, e.g. from a hollow of a fixture as described above. The method may comprise disassembling the (first) flexible element from the rotor and/or fixture prior to assembling the (second) flexible element to the rotor/fixture.

The various embodiments of the present disclosure having been described above in general terms, the embodiments shown in the Figures will now be elucidated.

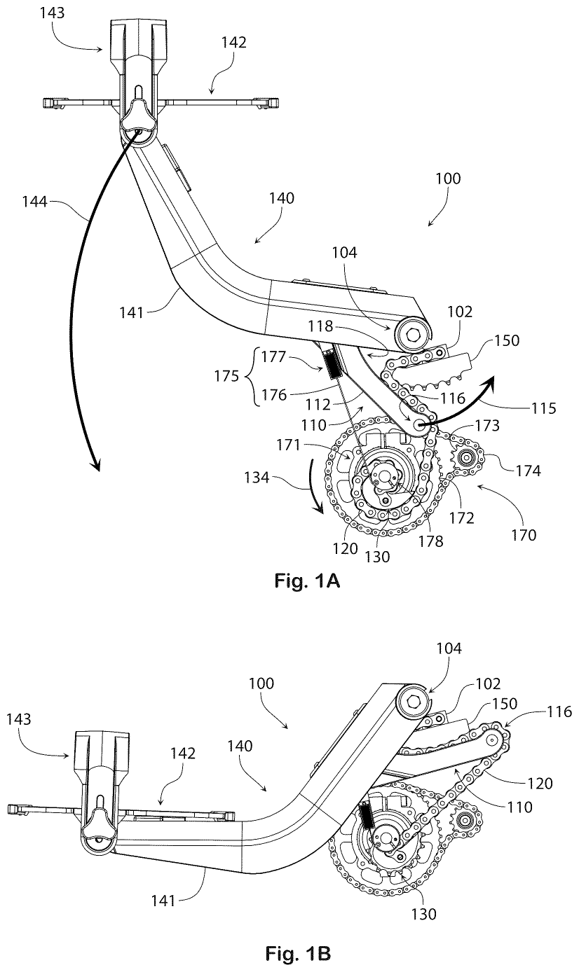

FIG. 1A shows a schematic depiction of an apparatus 100 in accordance with the present disclosure, e.g. as described above. In the depicted embodiment, apparatus 100 is shown as comprising a fixture 102, a pivot 104, a pusher 110, a flexible element 120, a rotor 130, a pedal 140, a guide 150, a transmission 170, and a retractor 175. Pusher 110 comprises an arm 112, a rotary element (not visible), a distal end 116, and a proximate end 118. A first end of flexible element 120 is secured to fixture 102; a second end of flexible element 120 is attached to rotor 130. In FIG. 1A, both pedal 140 and pusher 110 are in a respective unactuated position, and a portion of flexible element 120 is wrapped on an outer circumference of rotor 130. Pedal 140 comprises an arm 141, a foot-receiving portion 142, and a foot clip 143. Pedal 140 is pivotably mounted to pivot 104 and is moveable along a pivot path 144 in response to a pedaling motion by the user. Guide 250 engages flexible element 120 and influences a path thereof. Transmission 170 comprises a clutch 171, a first sprocket 172, a second sprocket 173, and a chain 174. Rotor 130 constitutes an input shaft of clutch 171. First sprocket 172 is mounted on an output shaft of clutch 171. Chain 174 connects first sprocket 172 and second sprocket 173 to effect a change of gear ratio between rotor 130 and second sprocket 173. Retractor 175 comprises a belt 176, a spring 177, and a cylinder 178. A first end of belt 176 is attached to a cylinder 178 that rotates with rotor 130. A second end of belt 176 is attached to arm 141 of pedal 140 via spring 177. Proximal end 118 of pusher 110 is mounted to arm 141 of pedal 140. In response to a pivoting of pedal 140, distal end 116 of pusher 110 moves along a first path 115 from the unactuated position shown in FIG. 1A. Motion of distal end 116 along first path 115 lengthens a path of flexible element 120 from fixture 102 to rotor 130 and draws flexible element 120 from the outer circumference of rotor 130, thus causing rotor 130 and first sprocket 172 to rotate in a driving direction 134 and causing a portion of belt 176 to wind onto an outer circumference of rotor 130.

FIG. 1B schematically depicts further aspects of apparatus 100 of FIG. 1A. In FIG. 1B, both pedal 140 and pusher 110 have pivoted from their respective unactuated positions shown in FIG. 1A to their respective, fully actuated positions. A length of the path of flexible element 120 from fixture 102 to rotor 130 is at a maximum, flexible element 120 is unwound from the outer circumference of rotor 130, and a portion of belt 176 is wound onto cylinder 178.

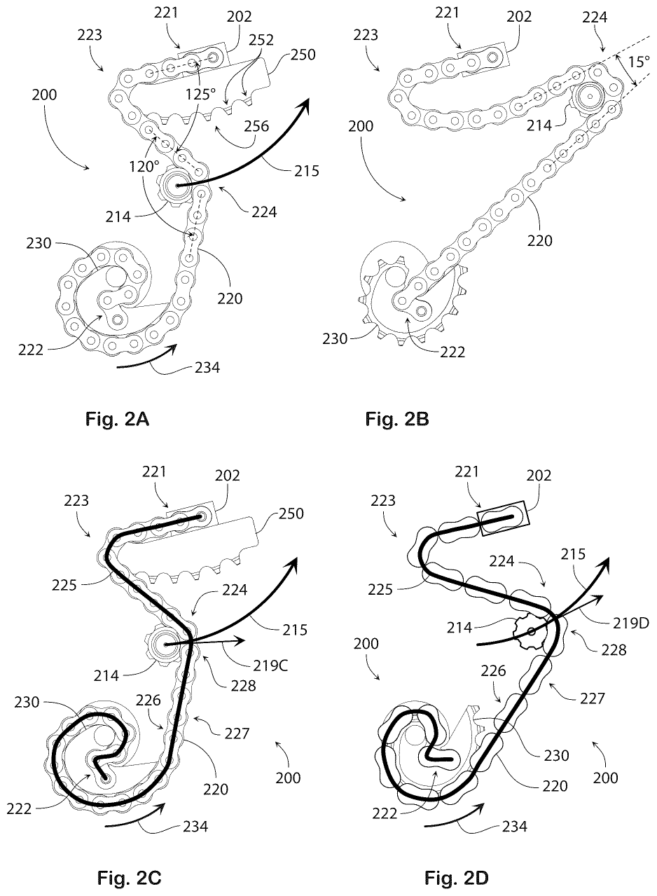

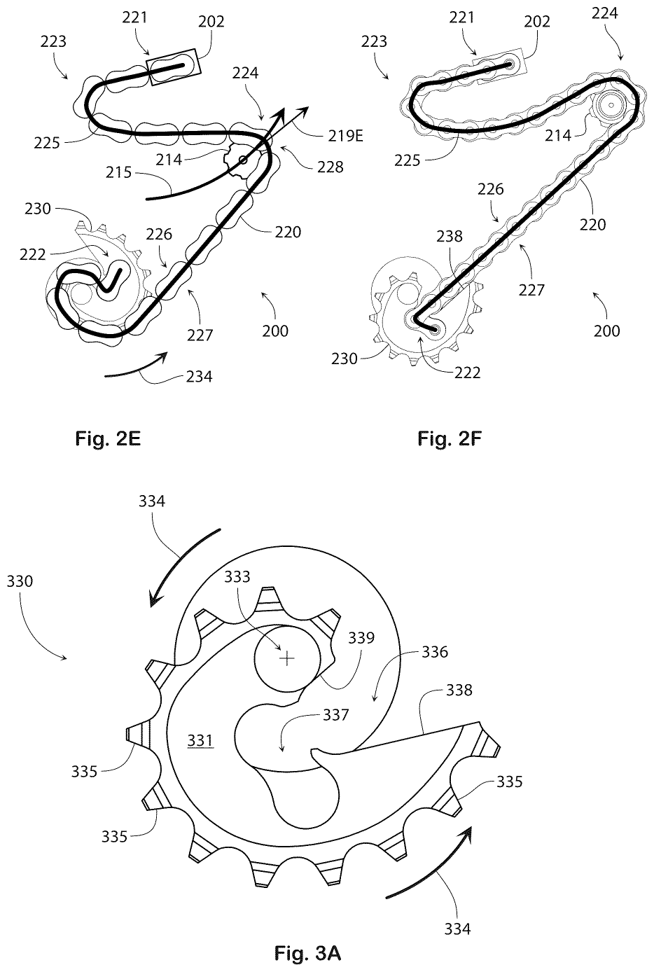

FIG. 2A shows a schematic depiction of an apparatus 200 in accordance with the present disclosure, e.g. as described above. In the depicted embodiment, apparatus 200 is shown as comprising a fixture 202, a rotary element 214 of a pusher (not shown), a flexible element 220, a rotor 230, and a guide 250. A first end 221 of flexible element 220 is secured to fixture 202; a second end 222 of flexible element 220 is attached to rotor 230. Flexible element 220 comprises a first bend 223 in a first direction of curvature in a first end portion that abuts guide 250 and a second bend 224 in an opposite direction of curvature in pusher-contacting portion 228 that abuts rotary element 214. In FIG. 2A, rotary element 214 is in an unactuated position, and a portion of flexible element 220 is wrapped on an outer circumference of rotor 230. In the state depicted in FIG. 2A, the first bend 223 has an angle of 125° and the second bend has an angle of 120°. Guide 250 comprises an arch-shaped outer surface 256 and a plurality of teeth 252, some of which are situated on arch-shaped outer surface 256. Guide 250 engages flexible element 220 and influences a path thereof, with a state of engagement of teeth 252 and flexible element 220 being dependent on a state of apparatus 200. In response to a motion of the pusher (not shown), rotary element 214 moves along a first path 215 from the unactuated position shown in FIG. 2A. Motion of rotary element 214 along first path 215 lengthens a path of flexible element 220 from fixture 202 to rotor 230 and draws flexible element 220 from the outer circumference of rotor 230, thus causing rotor 230 to rotate in a driving direction 234.

FIG. 2B schematically depicts further aspects of apparatus 200 of FIG. 2A. In FIG. 2B, rotary element 214 has moved from the unactuated positions shown in FIG. 2A to a fully actuated position, and the angle of the second bend has shrunk to 15°. A length of the path of flexible element 220 from fixture 202 to rotor 230 is at a maximum, and flexible element 220 is unwound from the outer circumference of rotor 230.

FIG. 2C schematically depicts further aspects of apparatus 200 of FIG. 2A. As shown in FIG. 2C, an initial motion 219C of rotary element 214 from the unactuated position depicted in FIG. 2C toward the fully actuated position is perpendicular to a path 225 of flexible element 220 in a respective pusher-contacting portion 228 of flexible element 220. Furthermore, flexible element 220 comprises a first side 226 and a second side 227 opposite first side 227, which first side 226 contacts rotor 230 and rotary element 214.

FIG. 2D schematically depicts further aspects of apparatus 200 of FIG. 2A. In FIG. 2D, rotary element 214 has moved along first path 215 from the unactuated position shown in FIGS. 2A and 2C toward the fully actuated position shown in FIGS. 2B and 2F. Specifically, rotary element 214 has moved to a first intermediate position along first path 215, increasing a length of path 225 from fixture 202 to rotor 230 and drawing flexible element 220, whose first side 226 continues to contact rotor 230 and rotary element 214, from the outer circumference of rotor 230, thus causing rotor 230 to rotate in driving direction 234. At the same time, the movement of rotary element 214 from the unactuated position to the first intermediate position reduces the angle of second bend 224, thus increasing the rate at which flexible element 220 is drawn from rotor 230 per unit of movement of rotary element 214 along path 215. The reduction in angle is amplified by the decreasing radius of rotor 230. As further shown in FIG. 2D, an initial motion 219D of rotary element 214 from the first intermediate position depicted in FIG. 2D toward the fully actuated position is perpendicular to path 225 of flexible element 220 in a respective pusher-contacting portion 228 of flexible element 220.

FIG. 2E schematically depicts further aspects of apparatus 200 of FIG. 2A. In FIG. 2E, rotary element 214 has moved along first path 215 from the first intermediate position shown in FIG. 2D toward the fully actuated position shown in FIGS. 2B and 2F. Specifically, rotary element 214 has moved to a second intermediate position along first path 215, further increasing a length of path 225 from fixture 202 to rotor 230 and further drawing flexible element 220, whose first side 226 continues to contact rotor 230 and rotary element 214, from the outer circumference of rotor 230, thus causing rotor 230 to continue rotating in driving direction 234. At the same time, the movement of rotary element 214 from the first intermediate position to the second intermediate position further reduces the angle of second bend 224, thus further increasing the rate at which flexible element 220 is drawn from rotor 230 per unit of movement of rotary element 214 along first path 215. The reduction in angle is again amplified by the decreasing radius of rotor 230. As further shown in FIG. 2E, an initial motion 219E of rotary element 214 from the second intermediate position depicted in FIG. 2E toward the fully actuated position is perpendicular to path 225 of flexible element 220 in a respective pusher-contacting portion 228 of flexible element 220.

FIG. 2F schematically depicts further aspects of apparatus 200 of FIG. 2A. In FIG. 2F, rotary element 214 has moved along first path 215 from the second intermediate position shown in FIG. 2E to the fully actuated position shown in FIG. 2B, further reducing the angle of second bend 224, thus further increasing the rate at which flexible element 220 is drawn from rotor 230 per unit of movement of rotary element 214 along first path 215. The reduction in angle is again amplified by the decreasing radius of rotor 230. At the same time, the movement of rotary element 214 from the second intermediate position to the fully actuated position further increases a length of path 225 from fixture 202 to rotor 230 and further draws flexible element 220 from the outer circumference of rotor 230, thus causing rotor 230 to continue rotating in driving direction 234 until the attachment of flexible element 220 to rotor 230 prevents further rotation of rotor 230 and rotor 230 stops in a final rotational position. In this position, second side 227 of flexible element 220 abuts a radially inward facing surface 238 of rotor 230, thus also preventing further rotation of rotor 230 in driving direction 234.

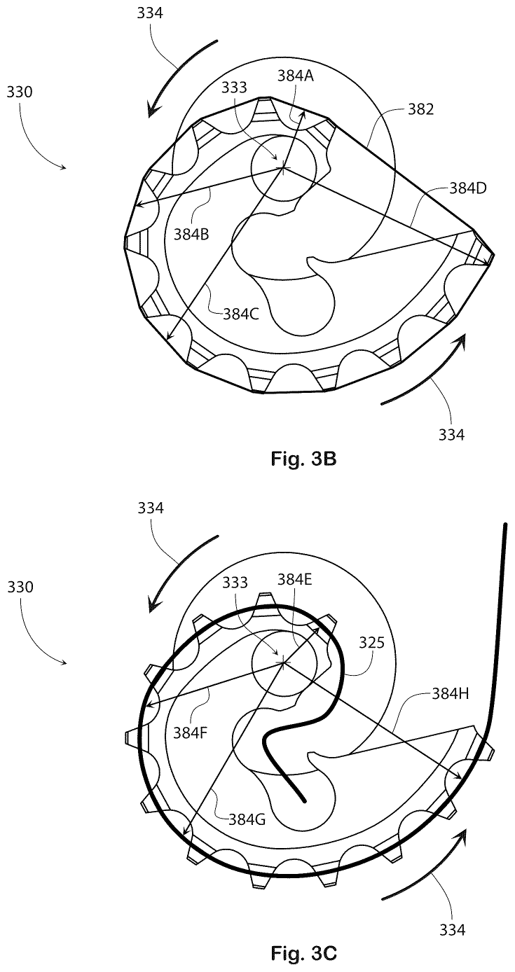

FIG. 3A shows a schematic depiction of a rotor 330 in accordance with the present disclosure, e.g. as described above. In the depicted embodiment, rotor 330 is shown as comprising a body 331, an axis of rotation 333, teeth 335, an undercut 336, a hollow 337, a radially inward facing surface 338, and an interior, radially outward facing surface 339. Rotor 330 is asymmetric and defines a driving direction 334. Teeth 335 are provided on an outer circumference of rotor 330. Undercut 336 in body 331 forms radially inward facing surface 338 and interior, radially outward facing surface 339. Hollow 337 is formed at an interior end of undercut 336.

FIG. 3B schematically depicts further aspects of rotor 330 of FIG. 3A. In FIG. 3B, rotor 330 is encircled by an imaginary shortest path 382 enclosing a circumference of the rotor. A first, shortest radius 384A from axis of rotation 333 to path 382 is shorter than a second radius 384B from axis of rotation 333 to path 382. Second radius 384B is shorter than a third radius 384C from axis of rotation 333 to path 382. Third radius 384C is shorter than a fourth, longest radius 384D from axis of rotation 333 to path 382.

FIG. 3C schematically depicts further aspects of rotor 330 of FIG. 3A. In addition to features depicted in FIG. 2A, FIG. 3C depicts a smooth path 325 of a flexible element (not shown) engaged with rotor 330. A first, shortest radius 384E from axis of rotation 333 to path 325 is shorter than a second radius 384F from axis of rotation 333 to path 325. Second radius 384F is shorter than a third radius 3846 from axis of rotation 333 to path 325. Third radius 384G is shorter than a fourth, longest radius 384H from axis of rotation 333 to path 325.

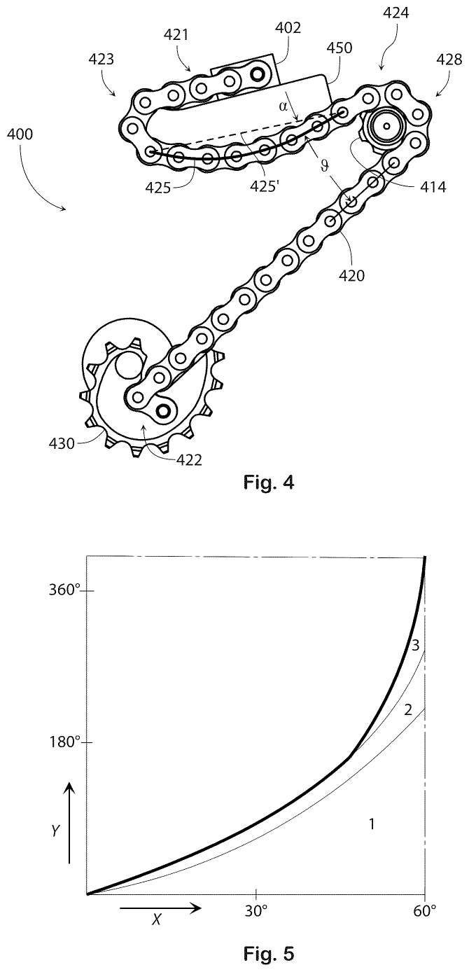

FIG. 4 shows a schematic depiction of an apparatus 400 in accordance with the present disclosure, e.g. as described above. In the depicted embodiment, apparatus 400 comprises a fixture 402, a rotary element 414 of a pusher (not shown), a flexible element 420, a rotor 430, and a guide 450. A first end 421 of flexible element 420 is secured to fixture 402; a second end 422 of flexible element 420 is attached to rotor 430. Rotary element 414 is in a fully actuated position, analogous to the depictions of FIGS. 1B, 2B, and 2F. Flexible element 420 comprises a first bend 423 in a first direction of curvature in a first end portion that abuts guide 450 and a second bend 424 in an opposite direction of curvature in pusher-contacting portion 428 that abuts rotary element 214. Guide 450 comprises an arch-shaped outer surface that alters a path 425 of flexible element 420 vis-á-vis a straight path 425′ that flexible element 420 would take if the arch-shaped outer surface were not arched. As shown in FIG. 4, the shape and position of guide 450 decreases an angle ϑ of second bend 424 by an angle α as rotary element 414 approaches the fully actuated position, thus further increasing a rate at which flexible element 420 is drawn from rotor 430 per unit of movement of rotary element 414.

FIG. 5 schematically depicts a power conversion ratio of an apparatus in accordance with the present disclosure, e.g. as described above. The x-axis, the scale of which is merely approximate, represents a pivotal motion of a pedal and/or pusher of the apparatus from the unactuated state to the fully actuated state. The y-axis, the scale of which is likewise merely approximate, represents an angle of rotation of a rotor of the apparatus resulting from the motion of the pedal and/or pusher. In the embodiment depicted in FIG. 5, a pivotal motion of the pedal/pusher from the unactuated state to the fully actuated state of roughly 60° yields a rotor rotation of roughly 360°, i.e. one full rotation. FIG. 5 furthermore schematically depicts the contributions of respective aspects of the apparatus to the power conversion ratio. The area marked as “1” represents an exemplary contribution of a motion of a pusher to the power conversion ratio. The area marked as “2” represents an exemplary contribution of an asymmetry of the rotor to the power conversion ratio. The area marked as “3” represents an exemplary contribution of a guide to the power conversion ratio.

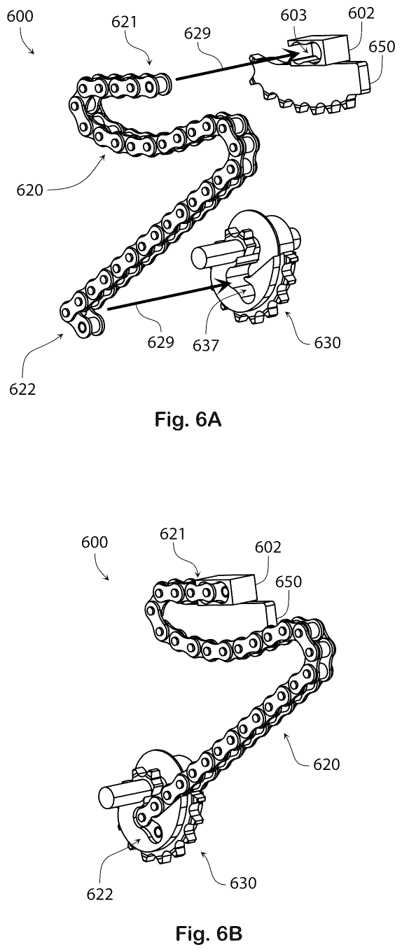

FIG. 6A shows a schematic depiction of an apparatus 600 in accordance with the present disclosure, e.g. as described above. In the depicted embodiment, apparatus 600 is shown as comprising a fixture 602, a flexible element 620, a rotor 630, and a guide 650. Fixture 602 comprises a hollow 603. Flexible element 620 comprises a first end 621 and a second end 622. Rotor 630 comprises a hollow 637. FIG. 6A depicts apparatus 600 in an unassembled state. As depicted in FIG. 6A, first end 621 may be manually assembled into hollow 603 and second end 622 may be manually assembled into hollow 637 by a motion 629 in a direction perpendicular to preferred bending plane of flexible element 620.

FIG. 6B schematically depicts further aspects of apparatus 600 of FIG. 6A. FIG. 6B depicts apparatus 600 in an assembled state with first end 621 matingly received by hollow 603 and second end 622 matingly received by hollow 637.

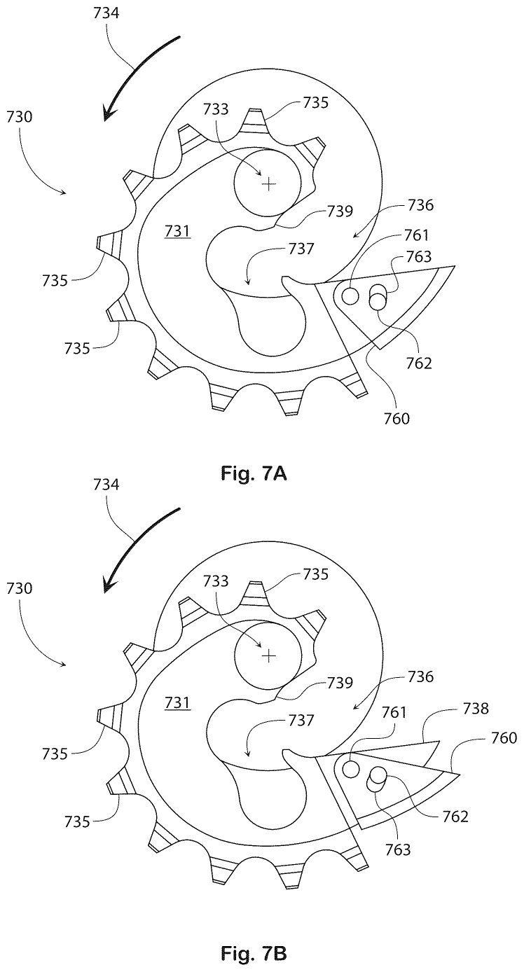

FIG. 7A shows a schematic depiction of a rotor 730 in accordance with the present disclosure, e.g. as described above. In the depicted embodiment, rotor 730 is shown as comprising a body 731, an axis of rotation 733, teeth 735, an undercut 736, a hollow 737, a radially inward facing surface 738, an interior, radially outward facing surface 739, and an adjustor 760. Rotor 730 is asymmetric and defines a driving direction 734. Teeth 735 are provided on an outer circumference of rotor 730. Undercut 736 in body 731 forms radially inward facing surface 738 and interior, radially outward facing surface 739. Hollow 737 is formed at an interior end of undercut 736. Adjustor 760 is pivotably mounted via a pivot 761 to body 731 and comprises a hole 763 that permits adjustor 760 to be affixed to body 731 at several different positions. A mounting screw 762 affixes adjustor 760 to body 731 at a desired position. In FIG. 7A, adjustor 760 is affixed to body 731 in a retracted position.

FIG. 7B schematically depicts further aspects of rotor 730 of FIG. 7A. In FIG. 7B, adjustor 760 is affixed to body 731 in an extended position that increases a radius from axis of rotation 733 to an outermost circumference of adjustor 760 vis-á-vis the retracted position shown in FIG. 7A.

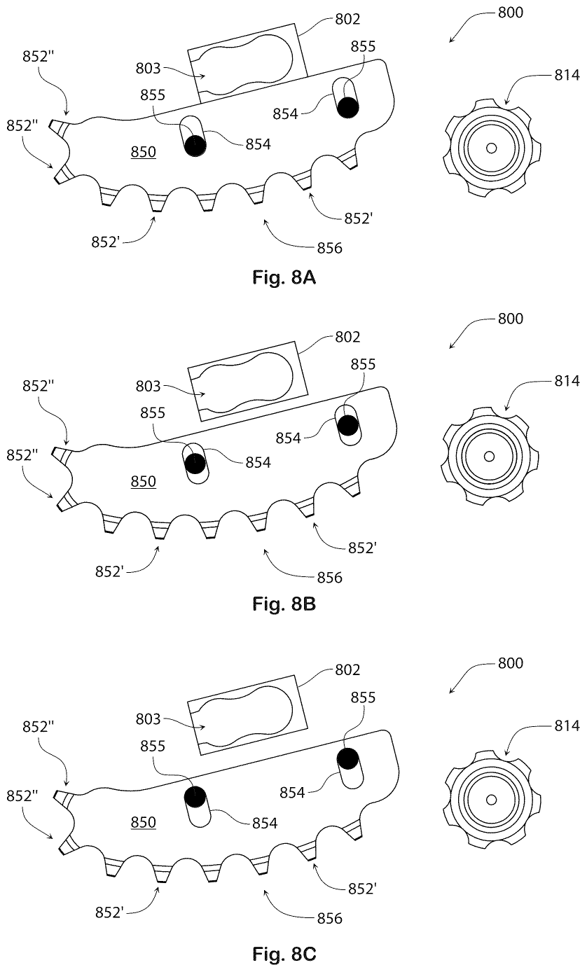

FIG. 8A shows a schematic depiction of an apparatus 800 in accordance with the present disclosure, e.g. as described above. In the depicted embodiment, apparatus 800 comprises a fixture 802, a rotary element 814 of a pusher (not shown), and a guide 850. Fixture 802 comprises a hollow 803 for receiving an end of a flexible element (not shown). Rotary element 814 is depicted in a fully actuated position, analogous to the depictions of FIGS. 1B, 2B, and 2F. Guide 850 comprises an arch-shaped outer surface 856, a plurality of teeth 852′ situated on arch-shaped outer surface 856, a plurality of teeth 852″ situated on a lateral surface of guide 850, and mounting slots 854. Mounting screws 855 extend through mounting slots 854 to secure guide 850 to a frame (not shown). FIG. 8A shows guide 850 in an uppermost position relative to the frame.

FIG. 8B schematically depicts further aspects of apparatus 800 of FIG. 8A. In FIG. 8B, guide 850 is in a medium position relative to the frame (not shown). Repositioning of guide 850 from the uppermost position shown in FIG. 8A to the medium position alters an angle of a path from guide 850 to rotary element 814 in manner analogous to the change shown in FIG. 4.

FIG. 8C schematically depicts further aspects of apparatus 800 of FIG. 8A. In FIG. 8C, guide 850 is in a lowermost position relative to the frame (not shown). Repositioning of guide 850 from the medium position shown in FIG. 8B to the lowermost position alters an angle of a path from guide 850 to rotary element 814 in manner analogous to the change shown in FIG. 4.

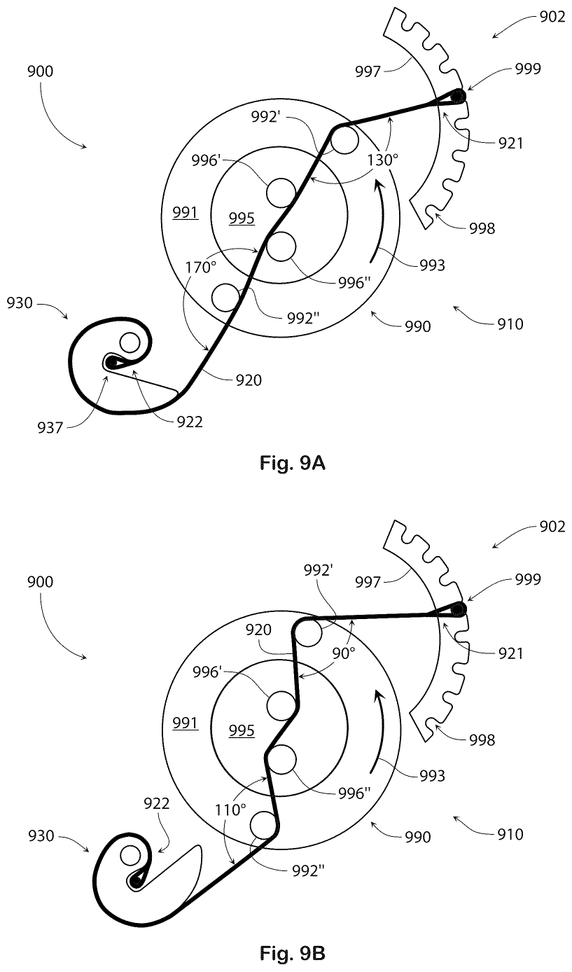

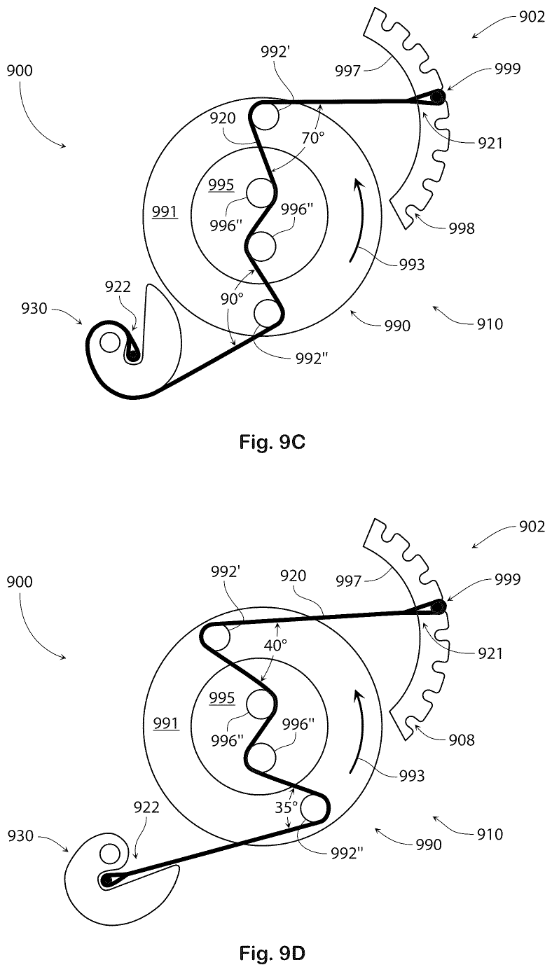

FIG. 9A shows a schematic depiction of an apparatus 900 in accordance with the present disclosure, e.g. as described above. In the depicted embodiment, apparatus 900 comprises a fixture 902, a pusher 910, a flexible element 920, and a rotor 930. Fixture 902 has the form of a rack 997. A first end 921 of flexible element 920 is secured via a rod 999. A second end 922 of flexible element 920 is secured to rotor 930 in a hollow 937 of rotor 930. Flexible element 920 has the form of a flat belt. In the depicted embodiment, pusher 910 is a rotary pusher 990 comprising a rotatable body 991 rotatably mounted on a stationary body 995. Rollers 992′, 992″ are mounted on rotatable body 991. Rollers 996′, 996″ are mounted on stationary body 995. Rollers 992′, 992″, 996′, 996″ form a path that contacts alternating sides of flexible element 920. FIG. 9A shows pusher 910 in an unactuated position, ready for rotation in a driving direction 993. A portion of flexible element 920 is wrapped on an outer circumference of rotor 930. The configuration of first end 921, roller 992′, and roller 996′ forms a first bend in flexible element 920 having an angle of 130°. The configuration of rotor 930, roller 992″, and roller 996″ forms a second bend in flexible element 920 having an angle of 170°. Rack 997 comprises a plurality of notches 998 along an equidistant arc relative to a contact point of flexible element 920 and roller 992′. The choice of notch 998 at which rod 999 is secured to rack 997 influences the angle of the aforementioned first bend in every operating state of rotary pusher 990, thus influencing the rate at which flexible element 920 is drawn from rotor 930 per unit of rotation of rotatable body 991.

FIG. 9B schematically depicts further aspects of apparatus 900 of FIG. 9A. In FIG. 9B, pusher 910 has rotated toward the fully actuated position shown in FIG. 9D. Specifically, rotatable body 991 has rotated to a first intermediate position, increasing a length of a path of flexible element 920 from fixture 902 to rotor 930 and drawing flexible element 920 from the outer circumference of rotor 930, thus causing rotor 930 to rotate. At the same time, the rotation of rotatable body 991 from the unactuated position to the first intermediate position reduces the angle of the aforementioned first bend to 90° and reduces the angle of the aforementioned second bend to 110°, thus increasing the rate at which flexible element 920 is drawn from rotor 930 per unit of rotation of rotatable body 991. The reduction of the angle of the second bend is amplified by the decreasing radius of rotor 930.

FIG. 9C schematically depicts further aspects of apparatus 900 of FIG. 9A. In FIG. 9C, pusher 910 has further rotated toward the fully actuated position shown in FIG. 9D. Specifically, rotatable body 991 has rotated to a second intermediate position, further increasing a length of the path of flexible element 920 from fixture 902 to rotor 930 and further drawing flexible element 920 from the outer circumference of rotor 930, thus causing further rotation of rotor 930. At the same time, the rotation of rotatable body 991 from the first intermediate position to the second intermediate position reduces the angle of the aforementioned first bend to 70° and reduces the angle of the aforementioned second bend to 90°, thus further increasing the rate at which flexible element 920 is drawn from rotor 930 per unit of rotation of rotatable body 991. Again, the reduction of the angle of the second bend is amplified by the decreasing radius of rotor 930. In the depicted second intermediate position, rollers 992′, 992″, 996′, 996″ are in linear arrangement.

FIG. 9D schematically depicts further aspects of apparatus 900 of FIG. 9A. In FIG. 9D, rotatable body 991 has rotated from the second intermediate position shown in FIG. 9C to the fully actuated position, further reducing the angle of the aforementioned first bend to 40° and the angle of the aforementioned second bend to 35°, thus further increasing the rate at which flexible element 920 is drawn from rotor 930 per unit of rotation of rotatable body 991. The reduction of the angle of the second bend is again amplified by the decreasing radius of rotor 930. At the same time, the rotation of rotatable body 991 from the second intermediate position to the fully actuated position further increases a length of the path of flexible element 930 from fixture 902 to rotor 930 and further draws flexible element 920 from the outer circumference of rotor 930, thus causing rotor 930 to continue rotating until the attachment of flexible element 920 to rotor 930 prevents further rotation of rotor 930 and rotor 930 stops in a final rotational position.

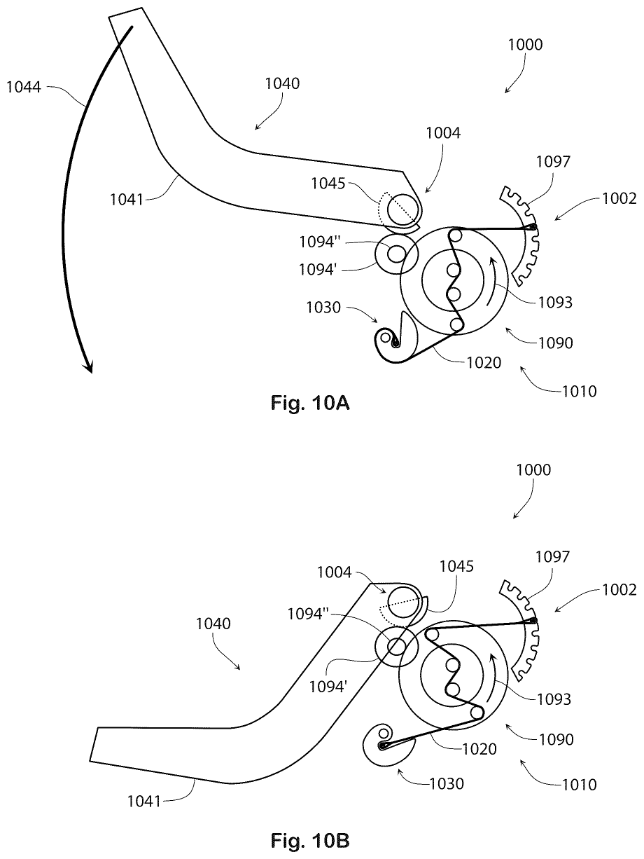

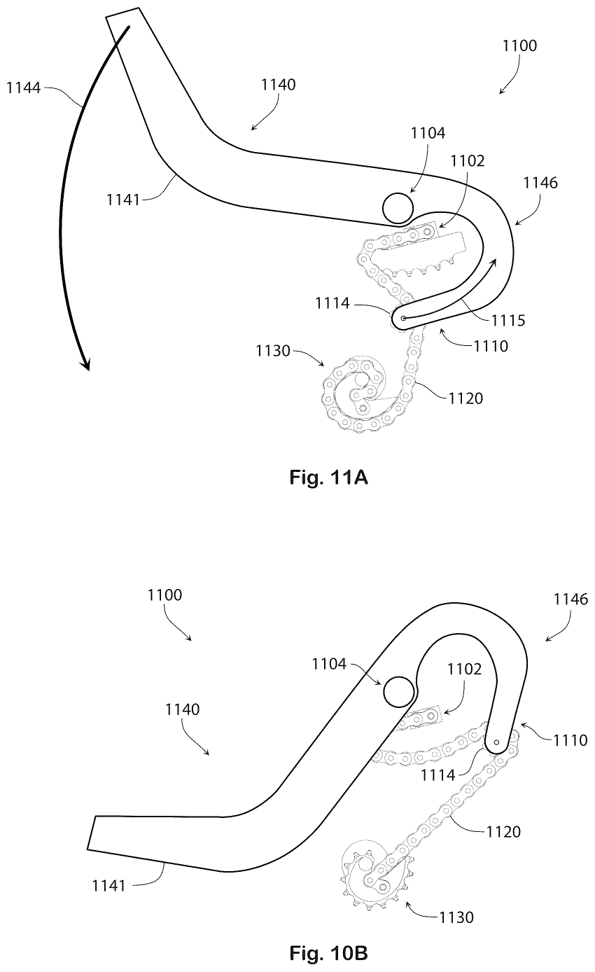

FIG. 10A shows a schematic depiction of an apparatus 1000 in accordance with the present disclosure, e.g. as described above. In the depicted embodiment, apparatus 1000 is shown as comprising a fixture 1002, a pivot 1004, a pusher 1010, a flexible element 1020, a rotor 1030, a pedal 1040, and gears 1094′, 1094″. Fixture 1002 has the form of a rack 1097. A first end of flexible element 1020 is secured to fixture 1002, and a second end of flexible element 1020 is secured to rotor 1030. Flexible element 1020 has the form of a flat belt. In the depicted embodiment, pusher 1010 is a rotary pusher 1090. FIG. 10A shows pusher 1010 in an unactuated position. A portion of flexible element 1020 is wrapped on an outer circumference of rotor 1030. Pedal 1040 comprises an arm 1041 and a gear 1045. Pedal 1040 is pivotably mounted to pivot 1004 and is moveable along a pivot path 1044 in response to a pedaling motion by the user. In response to a pivoting of pedal 1040, gear 1045 rotates with arm 1041, gear 1045 transfers rotational power to rotary pusher 1090 via coaxial gears 1094′, 1094″, and rotary pusher 1090 rotates in a driving direction 1034. This rotation of rotary pusher 1090 lengthens a path of flexible element 1020 from fixture 1002 to rotor 1030 and draws flexible element 1020 from the outer circumference of rotor 1030, thus causing rotor 1030 to rotate.

FIG. 10B schematically depicts further aspects of apparatus 1000 of FIG. 10A. In FIG. 10B, both pedal 1040 and pusher 1010 have moved from their respective unactuated positions shown in FIG. 10A to their respective, fully actuated positions. A length of the path of flexible element 1020 from fixture 1002 to rotor 1030 is at a maximum, and flexible element 1020 is unwound from the outer circumference of rotor 1030.

FIG. 11A shows a schematic depiction of an apparatus 1100 in accordance with the present disclosure, e.g. as described above. In the depicted embodiment, apparatus 1100 is shown as comprising a fixture 1102, a pivot 1104, a pusher 1110, a flexible element 1120, a rotor 1130, and a pedal 1140. A first end of flexible element 1120 is secured to fixture 1102, and a second end of flexible element 1120 is secured to rotor 1130. In the depicted embodiment, pedal 1140 comprises an arm 1141 and an extension 1146. Extension 1146 forms part of pusher 1110. Pusher 1110 further comprises a rotary element 1114 mounted at an end of extension 1146. FIG. 11A shows pusher 1110 in an unactuated position. Pedal 1140 is pivotably mounted to pivot 1104 and is moveable along a pivot path 1144 in response to a pedaling motion by the user. In response to such a pivoting of pedal 1140, pusher 1110 moves toward the fully actuated position shown in FIG. 11B, pulling rotary element 1114 along path 1115 against flexible element 1130. The resulting pushing force exerted by rotary element 1114 against flexible element 1130 lengthens a path of flexible element 1120 from fixture 1102 to rotor 1130 and draws flexible element 1120 from the outer circumference of rotor 1130, thus causing rotor 1130 to rotate.

FIG. 11B schematically depicts further aspects of apparatus 1100 of FIG. 11A. In FIG. 11B, both pedal 1140 and pusher 1110 have moved from their respective unactuated positions shown in FIG. 11A to their respective, fully actuated positions. A length of the path of flexible element 1120 from fixture 1102 to rotor 1130 is at a maximum, and flexible element 1120 is unwound from the outer circumference of rotor 1130.

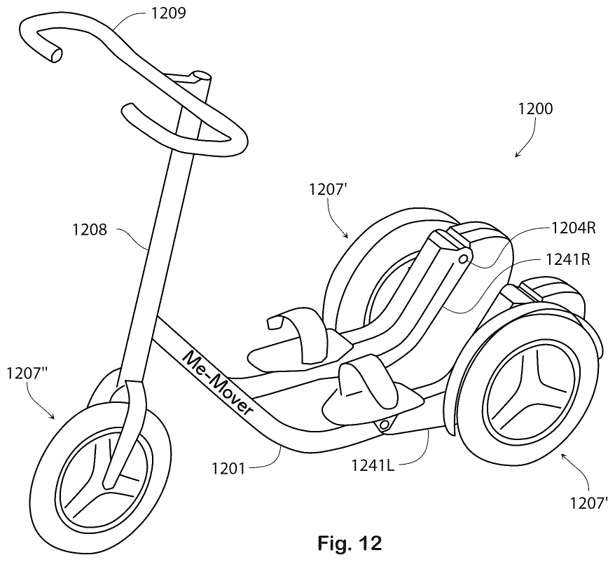

FIG. 12 shows a schematic depiction of an apparatus 1200 in accordance with the present disclosure, e.g. as described above. In the depicted embodiment, apparatus 1200 has the form of a human-power vehicle and comprises a frame 1201, a pivot 1204, two rear wheels 1207′, a front wheel 1207″, a steering column 1208, handlebars 1209, a left pedal 1241L, and a right pedal 1241R. Right pedal 1241R is pivotally mounted to frame 1201 via pivot 1204R in a rearward portion of the vehicle.

In the present disclosure, the verb “may” is used to designate optionality/noncompulsoriness. In other words, something that “may” can, but need not. In the present disclosure, the verb “comprise” may be understood in the sense of including. Accordingly, the verb “comprise” does not exclude the presence of other elements/actions. In the present disclosure, relational terms such as “first,” “second,” “top,” “bottom” and the like may be used solely to distinguish one entity or action from another entity or action without necessarily requiring or implying any actual such relationship or order between such entities or actions.

In the present disclosure, the term “any” may be understood as designating any number of the respective elements, e.g. as designating one, at least one, at least two, each or all of the respective elements. Similarly, the term “any” may be understood as designating any collection(s) of the respective elements, e.g. as designating one or more collections of the respective elements, wherein a (respective) collection may comprise one, at least one, at least two, each or all of the respective elements. The respective collections need not comprise the same number of elements.

In the present disclosure, the expression “at least one” is used to designate any (integer) number or range of (integer) numbers (that is technically reasonable in the given context). As such, the expression “at least one” may, inter alia, be understood as one, two, three, four, five, ten, fifteen, twenty or one hundred. Similarly, the expression “at least one” may, inter alia, be understood as “one or more,” “two or more” or “five or more.”

In the present disclosure, expressions in parentheses may be understood as being optional. As used in the present disclosure, quotation marks may emphasize that the expression in quotation marks may also be understood in a figurative sense. As used in the present disclosure, quotation marks may identify a particular expression under discussion.

In the present disclosure, many features are described as being optional, e.g. through the use of the verb “may” or the use of parentheses. For the sake of brevity and legibility, the present disclosure does not explicitly recite each and every combination and/or permutation that may be obtained by choosing from the set of optional features. However, the present disclosure is to be interpreted as explicitly disclosing all such combinations/permutations. For example, a system described as having three optional features may be embodied in seven different ways, namely with just one of the three possible features, with any two of the three possible features or with all three of the three possible features.

While various embodiments of the present invention have been disclosed and described in detail herein, it will be apparent to those skilled in the art that various changes may be made to the configuration, operation and form of the invention without departing from the spirit and scope thereof. In particular, it is noted that the respective features of the invention, even those disclosed solely in combination with other features of the invention, may be combined in any configuration excepting those readily apparent to the person skilled in the art as nonsensical. Likewise, use of the singular and plural is solely for the sake of illustration and is not to be interpreted as limiting. Except where the contrary is explicitly noted, the plural may be replaced by the singular and vice-versa.

The above disclosure may be summarized as comprising the following embodiments.

### Embodiment 1

An apparatus, comprising:
a pusher;
a flexible element; and
an asymmetric rotor, wherein
a path of said flexible element is a function of a position of said pusher, and
a rotational position of said asymmetric rotor is a function of said path.

### Embodiment 2

The apparatus of Embodiment 1, wherein:
in every operating state of said apparatus, said pusher contacts less than 20% of an overall length of said flexible element.

### Embodiment 3

The apparatus of Embodiment 1 or 2, wherein:
said apparatus is structured such that, in every operating state of said apparatus, an initial motion of said pusher toward a fully actuated position is perpendicular to said path in a region where said flexible element contacts said pusher.

### Embodiment 4

The apparatus of any one of Embodiments 1 to 3, wherein:
said path comprises a first bend of greater than 110° in a first end portion of said flexible element,
a second end of said flexible element is attached to said asymmetric rotor,
said path comprises a second bend in a portion of said flexible element in contact with said pusher, and
a direction of curvature of said first bend is opposite a direction of curvature of said second bend.

### Embodiment 5

The apparatus of any one of Embodiments 1 to 4, wherein:
in a first state of said apparatus, an angle between two portions of said flexible element adjacent to a portion of said flexible element in contact with said pusher is greater than 90°, and
in a second state of said apparatus, an angle between two portions of said flexible element adjacent to a portion of said flexible element in contact with said pusher is less than 45°.

### Embodiment 6

The apparatus of any one of Embodiments 1 to 5, wherein:
said asymmetric rotor comprises a body and an adjustor, and
a distance from the axis of rotation to a portion of said outer circumference defined by said adjustor is a function of a configuration of said adjustor and said body.

### Embodiment 7

The apparatus of any one of Embodiments 1 to 6, comprising:
a guide, wherein
said path of said flexible element is a function of a shape of said guide.

### Embodiment 8

The apparatus of Embodiment 7, wherein:
said path of said flexible element is a function of a position of said guide.

### Embodiment 9

The apparatus of Embodiment 7 or 8, comprising:
a frame, wherein
said guide is mountable to said frame in a first position,
said guide is mountable to said frame in a second position that differs from said first position, and
said guide is mountable to said frame in a third position that differs from said first position and said second position.

### Embodiment 10

The apparatus of any one of Embodiments 1 to 9, comprising:
a fixture, wherein
said apparatus is structured such that said flexible element is operatively engageable with said fixture and said asymmetric rotor by a motion of said flexible element in a direction perpendicular to a plane defined by said flexible element.

### Embodiment 11

The apparatus of any one of Embodiments 1 to 10, wherein:
in a third state of said apparatus, a portion of said flexible element abuts an outer circumference of said asymmetric rotor, and a second radial distance from an axis of rotation of said asymmetric rotor to a second location on said path is at least 1.5 times larger than a first radial distance from said axis of rotation to a first location on said path, and
said first location and said second location are situated within said portion of said flexible element that abuts said outer circumference.

### Embodiment 12

The apparatus of Embodiment 11, wherein:
in said third state of said apparatus, a third radial distance from said axis of rotation to a third location on said path is at least 2 times larger than said first radial distance, and
said third location is situated within said portion of said flexible element that abuts said outer circumference.

### Embodiment 13

The apparatus of any one of Embodiments 1 to 12, comprising:
at least one non-moving element that supports at least one of said pusher and said asymmetrical rotor, wherein
said apparatus defines an imaginary rectangular parallelepiped cuboid of 30 cm×30 cm×10 cm,
said imaginary rectangular parallelepiped cuboid is fixed relative to said at least one non-moving element, and
said apparatus is structured such that, in every operating state of said apparatus, said flexible element and said asymmetric rotor are situated entirely within said imaginary rectangular parallelepiped cuboid.

### Embodiment 14

A vehicle, comprising:
a frame;
a pedal movably attached to said frame;
a flexible element; and
an asymmetric rotor, wherein
a first end of said flexible element is attached to said frame at a first location,
a second end of said flexible element is attached to said asymmetric rotor,
said vehicle is structured such that a motion of said pedal toward said frame lengthens a path of said flexible element from said first location to said asymmetric rotor.

### Embodiment 15

The vehicle of Embodiment 14, wherein:
said pedal is pivotally attached to said frame at a rearward portion of said pedal.

### Embodiment 16

The vehicle of Embodiment 14 or 15, wherein:
said pedal is operable between a first position and a second position,
a motion of said pedal from said first position toward said frame moves said pedal toward said second position, and
said vehicle is structured such that an external force is required to move said pedal from said second position to said first position.

### Embodiment 17

The vehicle of any one of Embodiments 14 to 16, comprising:
a spring, wherein
said spring is attached to said pedal and to said asymmetric rotor,
said vehicle is structured to use said spring to return said asymmetric rotor to a first state, and
in said first state of said asymmetric rotor, a portion of said flexible element is wrapped around a portion of an outer circumference of said asymmetric rotor.

### Embodiment 18

The vehicle of any one of Embodiments 14 to 17, comprising:
a pushrod that extends from said pedal, wherein
a motion of said pedal toward said frame pushes said pushrod against said flexible element and lengthens said path of said flexible element from said first location to said asymmetric rotor.

### Embodiment 19

The vehicle of Embodiment 18, wherein:
in every operating state of said vehicle, said pushrod contacts less than 20% of an overall length of said flexible element.

### Embodiment 20

The vehicle of Embodiment 18 or 19, wherein:
said vehicle is structured such that, in every operating state of said vehicle, an initial motion of said pushrod toward a fully actuated position is perpendicular to a path of said flexible element in a region where said flexible element contacts said pushrod.

### Embodiment 21

The vehicle of any one of Embodiments 18 to 20, wherein:
a path of said flexible element comprises a first bend of greater than 110° in a first end portion of said flexible element that comprises said first end,
said path comprises a second bend in a portion of said flexible element in contact with said pushrod, and
a direction of curvature of said first bend is opposite a direction of curvature of said second bend.

### Embodiment 22

The vehicle of any one of Embodiments 18 to 21, wherein:
in a first state of said vehicle, an angle between two portions of said flexible element adjacent to a portion of said flexible element in contact with said pushrod is greater than 90°, and
in a second state of said vehicle, an angle between two portions of said flexible element adjacent to a portion of said flexible element in contact with said pushrod is less than 45°.

### Embodiment 23

The vehicle of any one of Embodiments 14 to 22, wherein:
said asymmetric rotor comprises a body and an adjustor, and
a distance from the axis of rotation to a portion of said outer circumference defined by said adjustor is a function of a configuration of said adjustor and said body.

### Embodiment 24

The vehicle of any one of Embodiments 14 to 23, comprising:
a guide, wherein
said path of said flexible element is a function of a shape of said guide.

### Embodiment 25

The vehicle of Embodiment 24, comprising:
said path of said flexible element is a function of a position of said guide.

### Embodiment 26

The vehicle of Embodiment 24 or 25, wherein:
said guide is mountable to said frame in a first position,
said guide is mountable to said frame in a second position that differs from said first position, and
said guide is mountable to said frame in a third position that differs from said first position and said second position.

### Embodiment 27

The vehicle of any one of Embodiments 14 to 26, comprising:
a fixture, wherein
said vehicle is structured such that said flexible element is operatively engageable with said fixture and said asymmetric rotor by a motion of said flexible element in a direction perpendicular to a plane defined by said flexible element.

### Embodiment 28

The vehicle of any one of Embodiments 14 to 27, wherein:
in a third state of said vehicle, a portion of said flexible element abuts an outer circumference of said asymmetric rotor, and a second radial distance from an axis of rotation of said asymmetric rotor to a second location on said path is at least 1.5 times larger than a first radial distance from said axis of rotation to a first location on said path, and
said first location and said second location are situated within said portion of said flexible element that abuts said outer circumference.

### Embodiment 29

The vehicle of Embodiment 28, wherein:
in said third state of said vehicle, a third radial distance from said axis of rotation to a third location on said path is at least 2 times larger than said first radial distance, and
said third location is situated within said portion of said flexible element that abuts said outer circumference.

### Embodiment 30

The vehicle of any one of Embodiments 14 to 29, wherein:
said vehicle defines an imaginary rectangular parallelepiped cuboid of 30 cm×30 cm×10 cm,
said imaginary rectangular parallelepiped cuboid is fixed relative to said frame, and
said vehicle is structured such that, in every operating state of said vehicle, said flexible element and said asymmetric rotor are situated entirely within said imaginary rectangular parallelepiped cuboid.

The following disclosure may be understood as being distinct from the preceding disclosure and as not limiting other portions of the present disclosure. Similarly, following disclosure may be understood as complementing the preceding disclosure.

The term “Belt”; or “Drive-Belt” may refer to a chain, belt, thread, or any other fixture capable of transforming pulling forces. The term “Variable Gear Ratio” may refer to a decreasing or increasing gear ratio depending on the movement of the pedal arm. In the following, the invention disclosed herein is termed the mechanical transmission system with a variable gear ratio, (the “Mechanical Transmission System”).

The Mechanical Transmission System pertains to the field of mechanical engineering, more specifically to the technical field of Gearing for Interconverting Rotary and Oscillating Motion. It is suitable for use in various fields such as step-bicycles, machinery and equipment. The invention can be applied to “rehab” equipment, stationary and/or dynamic fitness equipment, or any other equipment where the design requires a Variable Gear Ratio generated from an oscillating movement to a rotating motion.

The Mechanical Transmission System transforms an oscillating movement into a fully rotating movement and enables the gear ratio to increase or decrease during the oscillating movement. The Mechanical Transmission System is designed to efficiently convert an oscillating movement, specifically a downwards movement of approximately 60 degrees in the pedal-arm (141), into a rotating movement. This is achieved through a unique combination of different features. The invention consists of a Drive-Belt (120), that also may be a chain, attached to a variable radius gear-axle (130) through the Drive-Belt connecting with the top-fix plate (150) in the other end controlling the motion from the pedal arm (141). These features facilitate the creation of a Variable Gear Ratio between the movement of the pedal-arm and the rotation of the variable radius gear-axle. The Mechanical Transmission System is driven by the movement of the pushrod, which starts its movement in such a position that the Drive-Belt is nearly in a straight line. Further, the variable radius of the gear-axle increases (or decreases) during the oscillating movement of the pushrod's (110) movement, creating a rotating movement enabling more (or less) power and stepless gearing. The key features and their functionalities are described below.

### Feature 1: Movement of the Pushrod

A pushrod (110) is attached underneath the pedal-arm (141) and plays a crucial role in initiating the transmission process. As the pedal-arm (141) moves downward, the pushrod (110) moves backward, causing the angle of engagement between the Drive-Belt (120) and the pushrod pulley (116) to become more acute. This change in angle elongates the pulling length of the Drive-Belt relative to the downward or upward movement of the pedal-arm, thereby increasing or decreasing the rotation of the gear-axle. FIGS. 1B, 2A, and 2B provide detailed illustrations of this feature.

### Feature 2: Variable Radius on the Gear-Axle

To further enhance the gear ratio, the gear-axle (130) is designed with a variable radius. This design element contributes to accelerate the rotation of the gear-axle in relation to the downward movement of the pedal-arm (141). FIG. 3A illustrates this feature.

### Feature 3: Top-Fix Plate

To achieve a significant gear-ratio increase toward the lowest movement of the pedal-arm (141), a control mechanism including a specially shaped top-fix plate (150) is employed. This plate creates a curved path from the top-fix point to the engagement point of the Drive-Belt (120) on the pushrod pulley (116). The curvature of the top-fix plate (150) plays a vital role in further augmenting and controlling the increase or decrease of the gearing ratio during the movement of the pedal-arm (141). FIG. 4 provides a detailed illustration of this feature.

The combination of these three features constitutes the overall design principle of the Mechanical Transmission System and enables the creation of a variable gear ratio that effectively adapts to the required functionality of the Mechanical Transmission System. This is illustrated in detail through FIG. 5. Through the innovative combination of these features, the Mechanical Transmission System described herein offers improved efficiency, stepless gearing, and effective power transmission.

The Mechanical Transmission System comprises additional technical mechanisms supporting its functions and optimizing its performance.

The Mechanical Transmission System incorporates a freewheel mechanism that allows the wheel-axle drive belt (174) to seamlessly engage with a rotating system, even while it's already in motion. Unlike traditional systems, there's no need to interrupt the rotation for the belt to connect. The freewheel allows the belt to spin freely until the gear-axle (130) gradually synchronizes with the existing rotational speed. Once synchronized, the gear-axle seamlessly adds power to the rotating element, like spinning wheels, for enhanced performance.

It incorporates a screwless fixture feature (could be a Drive-Belt or a chain), which allows for a Drive-Belt to be mounted and maintained without any special tools or knowledge. The screwless plug in and plug out mechanism is illustrated in FIGS. 6A and 6B with a top-fix point (603) at the top-fix plate (150) and a lower connection point (637) in the gear-axle (130).

The Mechanical Transmission System also comprises additional design features making the mechanism adaptable and versatile.

The variable radius gear axle (130) has a design feature comprising a radius adjustment, mounting hole and adjustment-slot (FIG. 7A). By changing the position of the pins/screws mounted, the angle of the component will be adjusted allowing changing the gear ratio curve (FIG. 5) for the transmission system. The purpose of this could for instance be to improve the acceleration by having lighter gearing. This can be done without the use of any new components and is practical to adapt the transmission systems force for smaller or bigger devices, such as children's bikes or adult bikes.

The top-fix plate (150) has a design feature comprising two mounting slots (854) allowing the user repositioning the component (FIGS. 8B and 8C) to further influence the angle of the gearing curve (FIG. 5). Through its design feature this can be done without the need to change components.

The adjustments impact from the different components differs depending on the different phases of the movement of the pedal arm. The variable radius gear axle impacts during the first phase of the movement. After accelerating, both components support the mechanism maintaining cruising force. At top force it is primary the top-fix plate that induces a heavier or lighter gear to the Mechanical Transmission System.

The following describes operational use of the Mechanical Transmission System into a mechanical step-bicycle.

When a user engages with the step-bicycle and applies downward force on the pedal arm (141), the transmission system springs into action, converting the user's power into speed and movement. The process starts with the pushrod (110), which is attached underneath the pedal-arm (141). As the user pushes the pedal-arm (141) downwards, the pushrod (110) initiates the transmission process by moving backward.

As the pushrod (110) moves backward, the Drive-Belt (120) engages with the pushrod pulley (116). This engagement occurs at an angle (120° in FIG. 2A) that becomes increasingly acute as the pushrod moves backward (15° in FIG. 2B). This change in angle elongates the effective pulling length of the Drive-Belt (120) relative to the downward movement of the pedal-arm (141).

The increased pulling length of the Drive-Belt translates into more rotation of the gear-axle (130). Additionally, the gear-axle (130) incorporates a unique design feature-a variable radius (FIGS. 3B and 3C). As the pedal-arm (141) moves downward and the pushrod (110) engages with the Drive-Belt (120) and gear-axle (130), this declining (or increasing) radius feature causes the gear-axle (130) to rotate at an increasing (or decreasing) speed compared to the downward (or upward) movement of the pedal-arm (141). This amplifies the power output and results in an increase (or decrease) in speed and movement of the step-bicycle.

To optimize the gear ratio during the final phase of the pedal-arm (141) movement, a specially shaped top-fix plate (150) comes into play. This plate creates a curved path from the top-fix point to the engagement point of the Drive-Belt (120) on the pushrod pulley (116). This is illustrated in FIG. 4 (425, 425′). The curvature of the top-fix plate contributes to further amplifying the gear ratio, controlling the motion by ensuring smooth power transfer and efficient utilization of the user's downward force. The feature functions as a control mechanism ensuring a seamless transition as the pedal-arm reaches its lowest point, maintaining the momentum and speed of the step-bicycle. FIG. 5 illustrates the contribution of the three different features to the final gear ratio curve.

Lastly, the Mechanical Transmission system also comprises design features enabling the user to adjust the gear-ratio to fine-tune the power transfer and resistance depending on the specific needs of the application and user. By adjusting the radius of the variable radius gear-axle through its adjustable mounting screws (FIG. 7A), the fixture can be rotated outwards or inwards resulting in a new radius and thereby a new gear-ratio curve (FIG. 7B). Also, the top-fix plate may further refine the gear-ratio by adjusting it through its mounting slots (FIGS. 8A-8C). This ensures that the system can be tailored to optimize performance during different phases of operation, such as acceleration or cruising. Through this practical operation of the Mechanical Transmission System, the user's power is effectively harnessed, transformed, and transmitted to create speed and movement. The Mechanical Transmission System optimizes power utilization, providing a smooth and dynamic riding experience for the user when applied in a step-bicycle. It allows for efficient conversion of the user's physical exertion into forward motion, making the step-bicycle an ideal choice for exercise and movement.

In the Figures, the components are labeled as follows: Pedal (140), Pedal-arm (141), Pushrod (110), Pushrod pulley (116), Top-fix plate (150), Gear-axle (130), Return-belt (176), Return spring (177), Drive-Belt (120), Return disk (178), Wheel-axle (axle of sprocket 173), Wheel-axle drive belt (174), Large sprocket (172), Free-wheel (171), Pedal arm pivot point (104), Screwless fixture (603, 637), Radius-adjustment (760), Mounting hole (761), Adjustment-slot (763), Adjustable top-fix plate (850), Mounting-slot (854).

FIG. 1A provides an overview of the Mechanical Transmission System's components as viewed from the side with the pedal-arm in its top position. FIG. 1B is related to Feature 1 of the solution. It shows the transmission system with the pedal-arm (141) in its bottom position and is used in conjunction with FIGS. 2A and 2B to explain Feature 1. It illustrates the backward movement of the pushrod (110), which changes the angle of the Drive-Belt (120) around the pushrod pulley (116, 214).

FIGS. 2A and 2B illustrate Feature 1 of the solution and should be seen in relation to FIG. 1B. It illustrates the initial angle (120° in FIG. 2A) at the start of the downward movement of the pedal-arm (141) and the angle in its end position (15° in FIG. 2B).

FIGS. 3A-3C relates to Feature 2 of the solution. It illustrates the variable radius on the gear axle (130). Radius 384H represents the radius at the beginning of the downward movement of the pedal-arm (141), while radius 384E represents the radius near the end of the movement.

FIG. 4 illustrates Feature 3, highlighting the impact of the top-fix plate (150) which is responsible for the 3rd part of the gear ratio curve (FIG. 5) by controlling how much of the Drive-Belt can be used during one full pedal-arm stroke.

FIG. 5 combines the three main features of the transmission system (Feature 1, Feature 2, and Feature 3). The X-axis illustrates the downward movement of the pedal-arm (141), starting at the top position (as seen in FIG. 1A) and moving towards the bottom position (FIG. 1B). The total movement of the pedal-arm (141) is approximately 60 degrees. The Y-axis in FIG. 5 illustrates the corresponding variable rotation of the gear-axle (130), which completes approximately one full rotation, 360 degrees, for a full stroke of the pedal-arm (141). The three distinct areas under the curve: 1, 2, and 3 represent the individual contributions of the three different features to the final combined gear ratio curve. It illustrates the interplay and the resulting Variable Gear Ratio curve achieved by the Mechanical Transmission system.

FIGS. 6A and 6B illustrate the impact of using a roller-chain or leaf-chain as the Drive-Belt, which may be any fixture feature instead of a chain or a belt. The chain fitted in the gear-axle (130) and the top-fix plate (150) through a special screwless fixture-feature (603, 637).

FIG. 7A provides a decomposed view of the variable radius gear-axle (130). FIG. 7B illustrates that the variable radius gear-axle has an adjustable feature. By loosening two mounting-screws mounted in the mounting hole (761) holding the radius adjustment (760), the radius adjustment can be rotated outwards or inwards using the adjustment slot (763). This will increase or decrease the resulting radius and thereby adjust the gear-ratio curve.

FIG. 8A provides a decomposed view of the adjustable top-fix plate (850). FIG. 8B illustrates that the top-fix plate has an adjustable feature. The adjustable top-fix plate (850) is mounted in two mounting slots (854) and by loosening the mounting screws the adjustable top fix-plate (850) can be moved up and down and thereby adjusting the gear ratio.

### Embodiment 1

A compact Mechanical Transmission System that transforms an oscillating motion into a rotation with a stepless variable gear-ratio, the Mechanical Transmission System solution comprises:
   A pushrod (110) connected at a first end to a pushrod pulley (116, 214), and at a second end connected to a pedal-arm (141) at a point between a first and a second end of the pedal arm (141),
   A pedal-arm pivot (104) point is rotatably connected to the pedal-arm (141) at a first end,
   A curved top-fix plate (150) is fixedly connected by the pedal-arm pivot point (104),
   A Main Drive-Belt, having a first and a second end, where the Main Drive Belt (120) at the first end, is fixedly connected to the top-fix plate (FIG. 1E) near the pedal-arm pivot point (104),
   A variable radius gear axle (130) is connected to the Main Drive-Belt (120) at the belts second end and the Main Drive-Belt (120) is further extending over the variable radius of the gear axle (130), characterized by, upon activation of the pedal-arm (141), the transmission system is configured to push the pushrod (110) and the pushrod pulley (116, 214) towards the Main Drive-Belt (120), in an oscillating movement, as to drive the Main Drive-Belt (120) over the top-fix plate (150) and thereby pulling the Main Drive-Belt (120) at its second end so that the variable radius gear axle (130) will be rotating.

### Embodiment 2

The Mechanical Transmission System according to Embodiment 1 comprises a variable radius gear-axle (130) which enables increasing or decreasing the gear ratio in conjunction with the movement of the pushrod (110) through its shape creating a variable radius when rotating (FIG. 3A).

### Embodiment 3

The Mechanical Transmission System according to Embodiments 1 and 2 comprises a control mechanism by employment of a top-fix plate (150) which allows the gear-ratio to increase or decrease depending on the movement of the pushrod (110), transforming the motion into a rotating movement of the variable radius gear-axle (FIG. 4).

### Embodiment 4

The Mechanical Transmission System according to Embodiment 1, 2 and 3 comprises a free-wheel mechanism (171) allowing the drive belt to engage with the rotational movements also when the mechanism is already in motion without putting the rotation to a stop creating a lasting transformation of the oscillating force.

### Embodiment 5

The Mechanical Transmission System according to Embodiment 1 comprises a screwless fixture feature (603, 637) enabling the mounting of the fixture by plugging it in or out, without the use of any tools.

### Embodiment 6

The mechanical Transmission system according to Embodiment 1, comprising a variable radius gear axle with a separate radius-adjustment design feature (760), rotatably adjustable, pivoting around a mounting hole (761) and guided by an adjustment-slot (763). The radius-adjustment (760) feature, allowing for a gear ratio adjustment, to enable an increase or decrease of the pre-set radius.

### Embodiment 7

A compact Mechanical Transmission system, according to Embodiment 1, comprising an adjustable top-fix plate (850) design feature with two mounting slots (854), to allow for a fixed adjustability of the adjustable top-fix plate (850), enabling a further adjustment of the Main Drive Belt's (120) extension over the adjustable top-fix plate (850).

1. An apparatus, comprising:
a pusher;
a flexible element; and
an asymmetric rotor, wherein
a path of said flexible element is a function of a position of said pusher, and
a rotational position of said asymmetric rotor is a function of said path.

2. The apparatus of claim 1, wherein:
in every operating state of said apparatus, said pusher contacts less than 20% of an overall length of said flexible element.

3. The apparatus of claim 1, wherein:
said apparatus is structured such that, in every operating state of said apparatus, an initial motion of said pusher toward a fully actuated position is perpendicular to said path in a region where said flexible element contacts said pusher.

4. The apparatus of claim 1, wherein:
said path comprises a first bend of greater than 110° in a first end portion of said flexible element,
a second end of said flexible element is attached to said asymmetric rotor,
said path comprises a second bend in a portion of said flexible element in contact with said pusher, and
a direction of curvature of said first bend is opposite a direction of curvature of said second bend.

5. The apparatus of claim 1, wherein:
in a first state of said apparatus, an angle between two portions of said flexible element adjacent to a portion of said flexible element in contact with said pusher is greater than 90°, and
in a second state of said apparatus, an angle between two portions of said flexible element adjacent to a portion of said flexible element in contact with said pusher is less than 45°.

6. The apparatus of claim 1, wherein:
said asymmetric rotor comprises a body and an adjustor, and
a distance from the axis of rotation to a portion of said outer circumference defined by said adjustor is a function of a configuration of said adjustor and said body.

7. The apparatus of claim 1, comprising:
a guide, wherein
said path of said flexible element is a function of at least one of a shape of said guide and a position of said guide.

8. The apparatus of claim 7, comprising:
a frame, wherein
said guide is mountable to said frame in a first position,
said guide is mountable to said frame in a second position that differs from said first position, and
said guide is mountable to said frame in a third position that differs from said first position and said second position.

9. The apparatus of claim 7, wherein:
said apparatus is structured such that said flexible element is operatively engageable with said guide and said asymmetric rotor by a motion of said flexible element in a direction perpendicular to a plane defined by said flexible element.

10. The apparatus of claim 1, wherein:
in a third state of said apparatus, a portion of said flexible element abuts an outer circumference of said asymmetric rotor, and a second radial distance from an axis of rotation of said asymmetric rotor to a second location on said path is at least 1.5 times larger than a first radial distance from said axis of rotation to a first location on said path, and
said first location and said second location are situated within said portion of said flexible element that abuts said outer circumference.

11. The apparatus of claim 10, wherein:
in said third state of said apparatus, a third radial distance from said axis of rotation to a third location on said path is at least 2 times larger than said first radial distance, and
said third location is situated within said portion of said flexible element that abuts said outer circumference.

12. A vehicle, comprising:
a frame;
a pedal movably attached to said frame;
a flexible element; and
an asymmetric rotor, wherein
a first end of said flexible element is attached to said frame at a first location,
a second end of said flexible element is attached to said asymmetric rotor,
said vehicle is structured such that a motion of said pedal toward said frame lengthens a path of said flexible element from said first location to said asymmetric rotor.

13. The vehicle of claim 12, wherein:
said pedal is pivotally attached to said frame at a rearward portion of said pedal,
said pedal is operable between a first position and a second position,
a motion of said pedal from said first position toward said frame moves said pedal toward said second position, and
said vehicle is structured such that an external force is required to move said pedal from said second position to said first position.

14. The vehicle of claim 12, comprising:
a pushrod that extends from said pedal, wherein
a motion of said pedal toward said frame pushes said pushrod against said flexible element and lengthens said path of said flexible element from said first location to said asymmetric rotor.

15. The vehicle of claim 14, wherein:
a path of said flexible element comprises a first bend of greater than 110° in a first end portion of said flexible element that comprises said first end,
said path comprises a second bend in a portion of said flexible element in contact with said pushrod, and
a direction of curvature of said first bend is opposite a direction of curvature of said second bend.

16. The vehicle of claim 14, wherein:
in a first state of said vehicle, an angle between two portions of said flexible element adjacent to a portion of said flexible element in contact with said pushrod is greater than 90°, and
in a second state of said vehicle, an angle between two portions of said flexible element adjacent to a portion of said flexible element in contact with said pushrod is less than 45°.

17. The vehicle of claim 12, wherein:
said asymmetric rotor comprises a body and an adjustor, and
a distance from the axis of rotation to a portion of said outer circumference defined by said adjustor is a function of a configuration of said adjustor and said body.

18. The vehicle of claim 12, comprising:
a guide, wherein
said path of said flexible element is a function of at least one of a shape of said guide and a position of said guide.

19. The vehicle of claim 18, wherein:
said guide is mountable to said frame in a first position,
said guide is mountable to said frame in a second position that differs from said first position, and
said guide is mountable to said frame in a third position that differs from said first position and said second position.

20. The vehicle of claim 18, wherein:
said vehicle is structured such that said flexible element is operatively engageable with said guide and said asymmetric rotor by a motion of said flexible element in a direction perpendicular to a plane defined by said flexible element.
